(19) United States
(12) Patent Application Publication
(10) Pub. No.: US 2015/0287275 A1
(43) Pub. Date: Oct. 8, 2015

(54) ELECTRONIC GAMING DEVICE WITH PERSISTENT STATE GAMING FUNCTIONALITY

(71) Applicant: Jerish Augustine, Snellville, GA (US)

(72) Inventor: Jerish Augustine, Snellville, GA (US)

(73) Assignee: CADILLAC JACK, Duluth, GA (US)

(21) Appl. No.: 14/243,372

(22) Filed: Apr. 2, 2014

(51) Int. Cl. G07F 17/32; G07F 17/34

(52) U.S. Cl. CPC G07F 17/3225; G07F 17/3213; G07F 17/34

(57) ABSTRACT

Examples disclosed herein relate to an electronic gaming device including a memory, a processor, and a plurality of reels. The memory may include one or more persistent state modules. A processor may generate one or more symbols to be located in the one or more areas. The processor may generate one or more persistent game play data. The processor may transfer the one or more persistent game play data.

### FIELD

The subject matter disclosed herein relates to an electronic gaming device. More specifically, the disclosure relates to providing one or more persistent state functionalities on a gaming device.

### INFORMATION

The gaming industry has numerous casinos located both worldwide and in the United States. A client of a casino or other gaming entity can gamble via various games of chance. For example, craps, roulette, baccarat, blackjack, and electronic games (e.g., a slot machine) where a person may gamble on an outcome.

Paylines of an electronic gaming device (e.g., a slot machine) are utilized to determine when predetermined winning symbol combinations are aligned in a predetermined pattern to form a winning combination. A winning event occurs when the player successfully matches the predetermined winning symbols in one of the predetermined patterns.

A player's entertainment while playing one or more games may be enhanced by utilizing one or more persistent state functionalities on the gaming device. By increasing the player's entertainment level, the player's enjoyment of the game may be enhanced, which may increase a player's game playing period.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is an illustration of game play on a gaming device, according to one embodiment.

FIG. 5B is an illustration of a persistent state game play on a gaming device, according to one embodiment.

FIG. 5C is an illustration of persistent state game play on a gaming device, according to one embodiment.

FIG. 5D is an illustration of persistent state game play on a gaming device, according to one embodiment.

FIG. 5E is another illustration of persistent state game play on a gaming device, according to one embodiment.

FIG. 5F is another illustration of persistent state game play on a gaming device, according to one embodiment.

FIG. 5G is another illustration of persistent state game play on a gaming device, according to one embodiment.

FIG. 5H is another illustration of persistent state game play on a gaming device, according to one embodiment.

FIG. 5J is another illustration of persistent state game play on a gaming device, according to one embodiment.

FIG. 5K is another illustration of persistent state game play on a gaming device, according to one embodiment.

FIG. 5L is another illustration of persistent state game play on a gaming device, according to one embodiment.

FIG. 6A is another illustration of persistent state game play on a gaming device, according to one embodiment.

FIG. 6B is another illustration of persistent state game play on a gaming device, according to one embodiment.

FIG. 6C is another illustration of persistent state game play on a gaming device, according to one embodiment.

FIG. 6D is another illustration of persistent state game play on a gaming device, according to one embodiment.

FIG. 6E is another illustration of persistent state game play on a gaming device, according to one embodiment.

FIG. 6F is another illustration of persistent state game play on a gaming device, according to one embodiment.

FIG. 6G is another illustration of persistent state game play on a gaming device, according to one embodiment.

FIG. 6H is another illustration of persistent state game play on a gaming device, according to one embodiment.

FIG. 6J is another illustration of persistent state game play on a gaming device, according to one embodiment.

FIG. 6K is another illustration of persistent state game play on a gaming device, according to one embodiment.

FIG. 7A is another illustration of persistent state game play on a gaming device, according to one embodiment.

FIG. 7B is another illustration of persistent state game play on a gaming device, according to one embodiment.

FIG. 7C is another illustration of persistent state game play on a gaming device, according to one embodiment.

FIG. 7D is another illustration of persistent state game play on a gaming device, according to one embodiment.

FIG. 7E is another illustration of persistent state game play on a gaming device, according to one embodiment.

FIG. 7F is another illustration of persistent state game play on a gaming device, according to one embodiment.

FIG. 7G is another illustration of persistent state game play on a gaming device, according to one embodiment.

FIG. 7H is another illustration of persistent state game play on a gaming device, according to one embodiment.

FIG. 7J is another illustration of persistent state game play on a gaming device, according to one embodiment.

FIG. 7K is another illustration of persistent state game play on a gaming device, according to one embodiment.

FIG. 8 is a game play flow diagram, according to one embodiment.

FIG. 9 is a game play flow diagram, according to one embodiment.

FIG. 10 is a flow diagram for game play, according to one embodiment.

FIG. 11 is a flow diagram for game play, according to one embodiment.

FIG. 12 is a flow diagram for game play, according to one embodiment.

### DETAILED DESCRIPTION

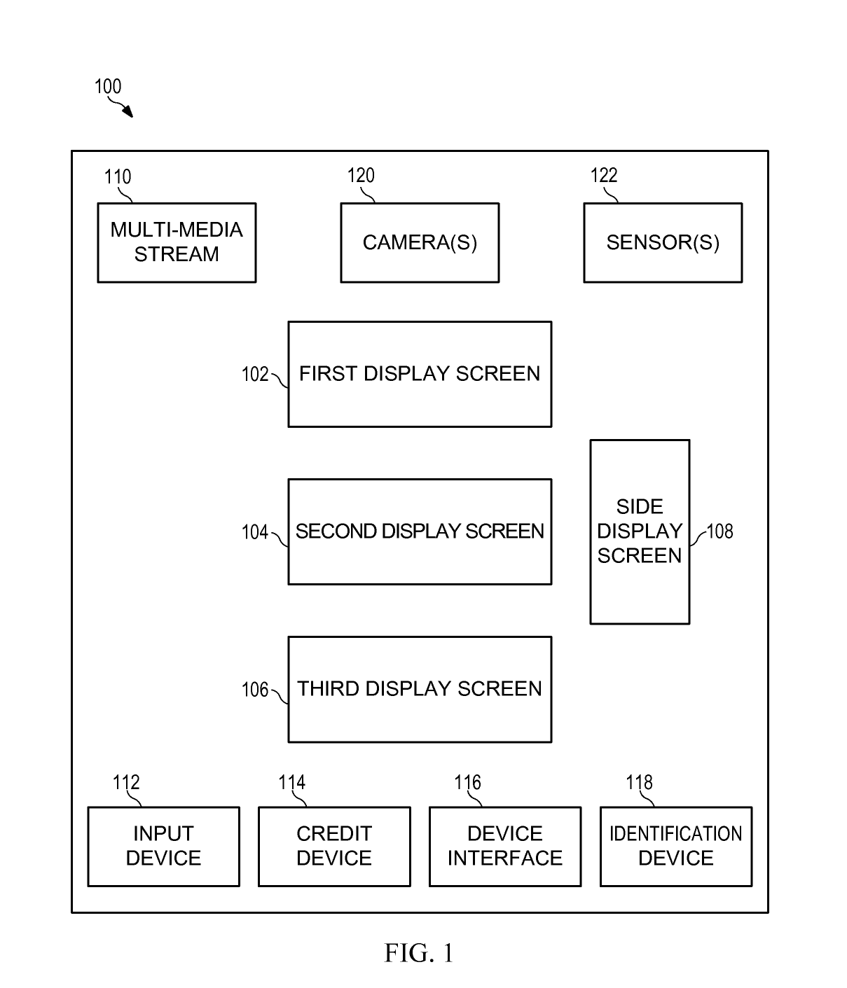

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, and an identification device 118. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to select one or more persistent state gaming options, to make a wager, to make a persistent state wager, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, the language, sound level, music, placement of multi-media streams, one or more game functionalities (e.g., game type 1, game type 2, game type 3, etc.) may be presented, a persistent state gaming option may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include persistent state gaming options only. Therefore, only games which include persistent state gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display one or more warnings relating to one or more audio devices, one or more display devices, one or more electrical wires, one or more springs, one or more motors, one or more adjustable devices, and/or one or more sensors, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

Electronic gaming device 100 may include at least one display device. Electronic gaming device 100 may include a base display and/or a second display. In one embodiment, base display may be the primary display for a first game and/or one or more persistent state games. In another embodiment, second display may be the primary display for a second, bonus game, and/or one or more persistent state games. For example, base display may display: a reel-type video slot game; and upon a bonus game triggering condition; second display may display a bonus game; and upon a persistent state game feature triggering event; first and/or second display (and/or Nth displays) may display a persistent state game feature. In various examples, the reserving an electronic gaming device function may be initiated and/or displayed on a first screen, a second screen, an Nth screen, and/or any combination thereof. In one example, a reserved game play function for a first player may be initiated, displayed, and played on a first screen of the electronic gaming device while a normal game play function for a second player may be initiated, displayed, and played on a second screen of the electronic gaming device.

In one embodiment, base display and second display may display separate portions of a common image. For example, second display may display a top portion of a wheel spinning while base display may display the bottom portion of the same wheel spinning.

Electronic gaming device 100 may also include one or more speakers. In one embodiment, one or more speakers may work in a synchronized manner to provide a surround sound effect. For example, as an object is displayed moving across base display from left to right, one or more speakers may produce sound in such a manner as to create an audible sense of similar left to right movement. In another embodiment, one or more speakers may work asynchronously. In a further embodiment, a first speaker may produce sounds associated with a first symbol appearing in a play of a game, and a second speaker may produce sounds associated with a second symbol appearing in a play of the game.

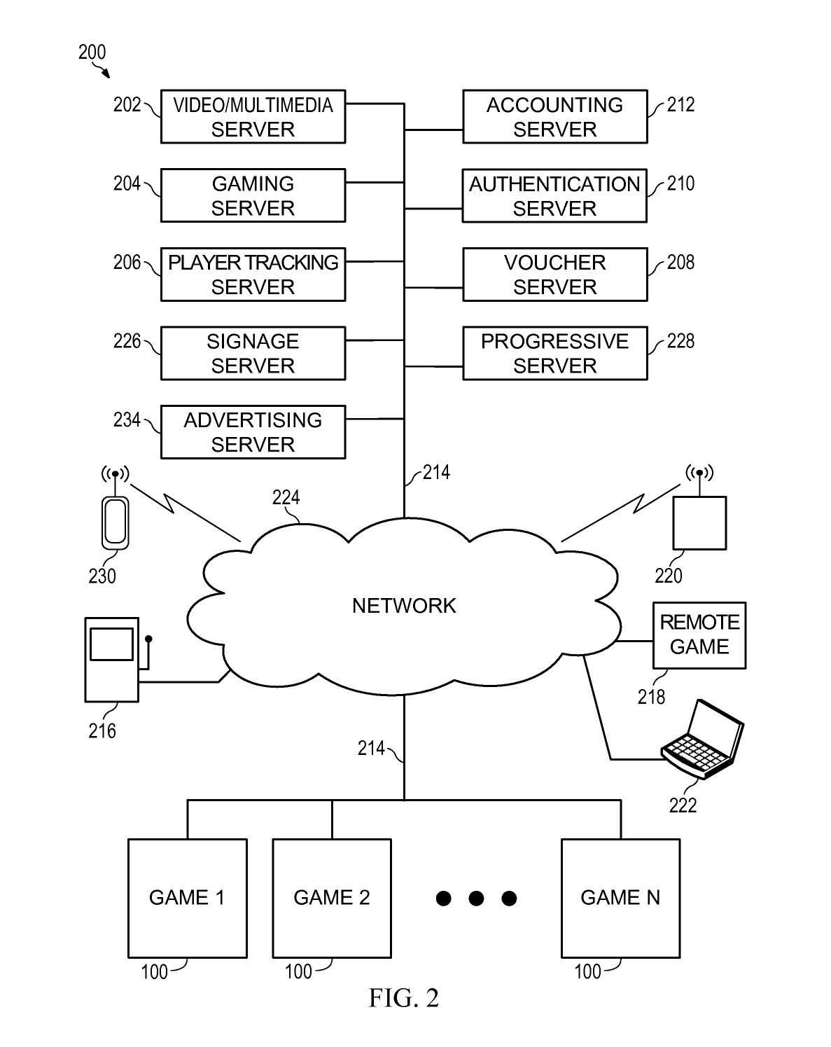

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities (including persistent state wagers) to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of: a persistent state game feature functionality; a persistent state game feature evaluation functionality; a payout functionality; a base and/or bonus game play functionality; a base and/or bonus game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.).

Voucher server 208 may generate a voucher, which may include data relating to gaming. Further, the voucher may include persistent state wagering data and/or payline structure option selections. In addition, the voucher may include game play data (or similar game play data), repeat payline data, pattern data, historical payout data, column data, row data, and/or symbols that were modified.

Authentication server 210 may determine the validity of vouchers, player's identity, and/or an outcome for a gaming event.

Accounting server 212 may compile, track, and/or monitor cash flows, voucher transactions, winning vouchers, losing vouchers, persistent state wagering data, and/or other transaction data. Transaction data may include the number of wagers, the size of these wagers, the date and time for these wagers, the identity of the players making these wagers, the frequency of the wagers, and/or verification data, and/or confirmation data. Accounting server 212 may generate tax information relating to these wagers. Accounting server 212 may generate profit/loss reports for players' tracked outcomes.

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play and/or persistent state wagering data for one or more electronic gaming devices 100 and/or other events. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Searching server 232 may implement a search on one or more gaming devices to obtain gaming data. Searching server 232 may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching server 232 may implement a wagering function, which may be an automatic wagering mechanism. These functions of searching server 232 may be integrated into one or more servers.

Searching server 232 may include one or more searching structures, one or more searching algorithms, and/or any other searching mechanisms. In general, the search structures may cover which EGMs paid out the most money during a time period, which EGMs kept the most money from players during a time period, which EGMs are the most popular (e.g., top games), which EGMs are the least popular, which EGMs have the most amount of money bet during a period, which EGMs have the highest bet volume, which EGMs are more volatile (e.g., volatility, or deviation from the statistical norms of bet volume, bet amount, pay out, etc.) during a time period, and the like. These searches may also be associated with location queries, time queries, and/or people queries (e.g., where are the electronic gaming machines that allow persistent game play options, where are the table games that most of my friends bet on, where are my favorite EGMs, what are players betting on the most today, when are most bets placed, etc.).

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., a first EGM type, a second EGM type, etc.). Searching structure may search one or more of these games. In one example, a player may utilize a searching function to find one or more games that allow persistent game play options and/or to find one or more specific game types (e.g., game theme 1) which the player may utilize to reload their persistent game configuration data and/or to restart a specific game type game play.

In another example, the searching structure may be based on a player's preferences, past transactional history, player input, a particular EGM, a particular casino, a particular location within a casino, game outcomes over a time period, payout over a time period, and/or any other criteria.

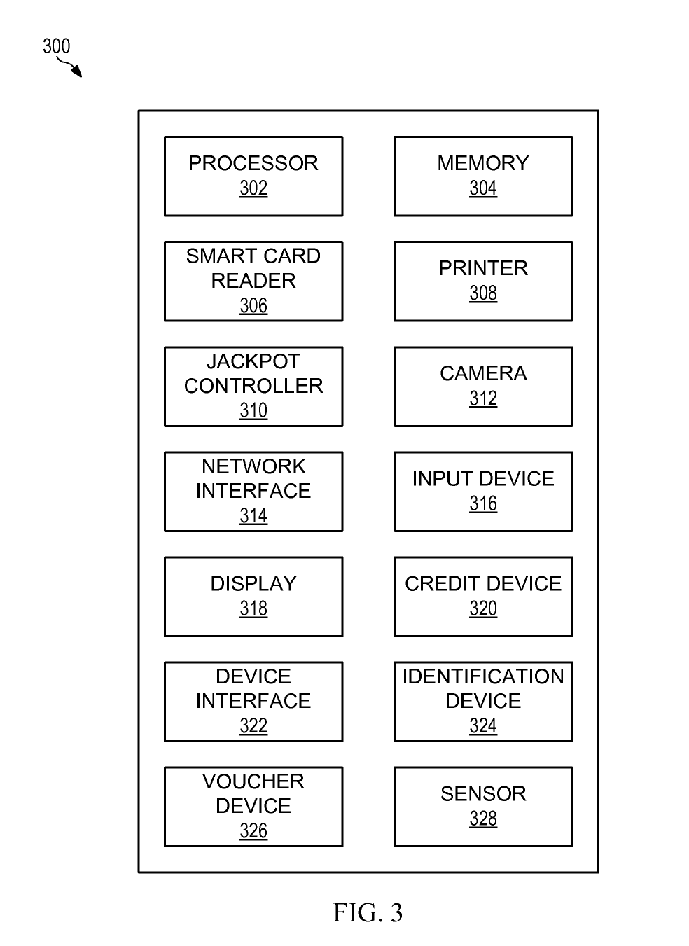

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher and/or a persistent game play receipt (and/or any other form). Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, persistent game play data receipts, persistent state wager payouts, persistent state wagering vouchers, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. For example, when a player sits down at the machine his or her picture may be taken to include his or her image into the game play. A picture of a player may be an actual image as taken by camera 312. A picture of a player may be a computerized caricature (i.e., avatar) of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes and/or a validating procedure (e.g., persistent gaming receipt validation, etc.). For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212, and/or any other persistent state wagering related server (e.g., server to confirm another event (e.g., a horse race, football game, etc.)).

Input device 316 may be mechanical buttons, electronic buttons, a touch screen, and/or any combination thereof. Input device 316 may be utilized to make a wager, to make a persistent state wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to modify one of one or more audio devices, one or more display devices, one or more electrical wires, one or more springs, one or more motors, one or more adjustable devices, and/or one or more sensors, to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money and/or credit. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.).

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, and/or any other wagering data. A voucher may represent an award, which may be used at other locations inside of the gaming establishment. For example, the voucher may be a coupon for the local buffet or a concert ticket.

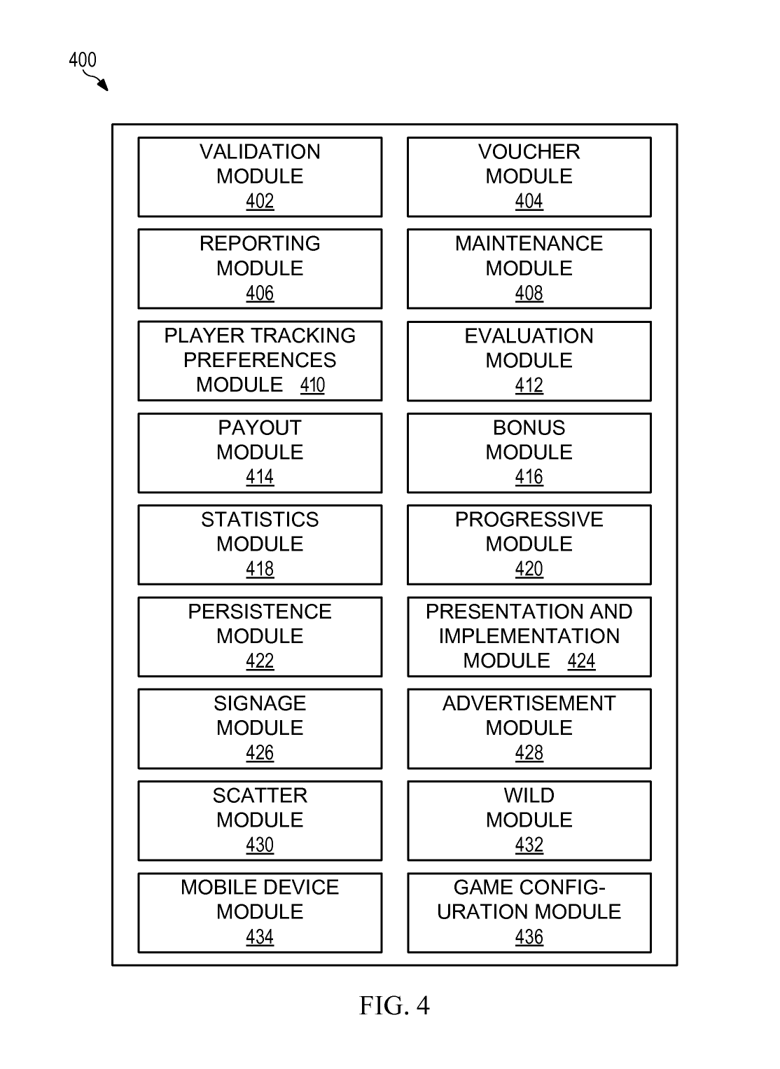

FIG. 4 shows a block diagram of memory 304, which includes various modules. Memory 304 may include a validation module 402, a voucher module 404, a reporting module 406, a maintenance module 408, a player tracking preferences module 410, an animation module, a game evaluation module 412, a payout module 414, a sensor module, a scene module, a sensor and scene evaluation module, a sensor and scene output module, a reference models module, an audio module, an audio device adjustment module, a display device adjustment module, a bonus module 416, a statistics module 418, a progressive module 420, a persistent state game module 422, a presentation and implementation module 424, a tracking module, a signage module 426, an advertisement module 428, a subscription-based progressive module, a 3D gesturing module, a pseudo module, a skill-based module, a scatter module 430, a wild module 432, a mobile device module 434, and a game configuration module 436.

Validation module 402 may utilize data received from voucher device 326 to confirm the validity of the voucher and/or a persistent gaming data (e.g., a persistent gaming receipt validation procedure).

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Animation module may generate, compile, transmit, and/or store one or more animations and/or presentations based on one or more scene data, one or more scenes, one or more reference models, one or more game play data, one or more player profiles, and/or any combination thereof.

Game evaluation module 412 may evaluate one or more outcomes for one or more events relating to game play.

Payout module 414 may determine one or more payouts which may relate to one or more inputs received from the player, electronic gaming device 100, and/or electronic gaming system 200.

Sensor module may generate, compile, transmit, and/or store any data relating to one or more scene data, one or more scene, and/or any other sensor data. This data may include one or more gestures (e.g., body movement made by one or more players).

Scene module may generate, compile, transmit, and/or store on one or more scene data, one or more scenes, one or more reference models, one or more game play data, one or more player profiles, and/or any combination thereof.

Sensor and scene evaluation module may evaluate any data stored on, transmitted to, and/or transmitted from sensor module and scene module. Sensor and scene evaluation module may obtain data including one or more gestures (e.g., body movement made by one or more players) from sensor module and compare this data to one or more body reference models, body part reference models, device reference models, gaming device reference models, floor plan reference models, and/or any other reference models from reference models module to determine one or more actions.

Sensor and scene output module may evaluate the combined output of sensor module and scene module.

Reference models module may generate, compile, transmit, and/or store one or more body reference models, body part reference models, device reference models, gaming device reference models, floor plan reference models, and/or any other reference models which can be utilized by any of the other modules.

Audio module may generate, compile, transmit, and/or store one or more audio structures, sound wave configurations, and/or any other audio data.

Audio device adjustment module may adjust one or more audio devices. These devices may be adjusted physically (e.g., moved) and/or by changing one or more device characteristics.

Display device adjustment module may adjust one or more display devices. These devices may be adjusted physically (e.g., moved) and/or by changing one or more device characteristics.

Bonus module 416 may generate a bonus game, evaluate the results of the bonus game, trigger bonus game presentations, generate bonus game payouts, and/or display any data relating to the bonus game.

Statistics module 418 may be used to maintain data relating to historical game play (including persistent state wagering data—(dollar amount, credit amount, spins, credits per line bet, time period, maximum win amount, one or more triggering events to stop game play, etc.)) for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Progressive module 420 may generate, transmit, compile, and/or store one or more data points relating to one or more progressives and/or subscription progressives (e.g., a progressive a player selects and pays to enter).

Persistent state game module 422 may generate, transmit, compile, and/or store one or more data points and/or presentations relating to one or more persistent state gaming options and/or persistent state gaming wagers.

Presentation and implementation module 424 may generate, transmit, compile, implement, and/or store one or more presentations.

Tracking module may generate, transmit, compile, and/or store one or more data points related to tracking one or more persistent state wagers and/or persistent state wager players.

Signage module 426 may generate, transmit, compile, initiate, and/or store one or more presentations for one or more signs.

Advertisement module 428 may generate, transmit, compile, present, implement, initiate, and/or store one or more advertisements.

Searching module may implement a search on one or more gaming devices to obtain gaming data. Searching module may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching module may implement a wagering function, which may be an automatic wagering mechanism. These functions of searching module may be integrated into one or more servers.

Searching module may include one or more searching structures, one or more searching algorithms, and/or any other searching mechanisms. In general, the search structures may cover which EGMs paid out the most money during a time period, which EGMs kept the most money from players during a time period, which EGMs are the most popular (e.g., top games), which EGMs are the least popular, which EGMs have the most amount of money bet during a period, which EGMs have the highest bet volume, which EGMs are more volatile (e.g., volatility, or deviation from the statistical norms of bet volume, bet amount, pay out, etc.) during a time period, and the like. These searches may also be associated with location queries, time queries, and/or people queries (e.g., where are the persistent state game play functionality games, where are theme 1 gaming machines, where are the table games that most of my friends bet on, where are my favorite EGMs, what are players betting on the most today, when are most bets placed, etc.).

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., a first EGM type, a second EGM type, etc.). Searching structure may search one or more of these games.

In another example, the searching structure may be based on a player's preferences, past transactional history, player input, a particular EGM, a particular casino, a particular location within a casino, game outcomes over a time period, payout over a time period, and/or any other criteria.

Wild module 432 may generate a wild game, evaluate the results of the wild game, trigger wild game presentations, generate wild game payouts, and/or display any data relating to the wild game. Further, wild module may determine one or more outcomes of one or more interactions (e.g., collisions of one or more symbols).

Scatter module 430 may generate a scatter game, evaluate the results of the scatter game, trigger scatter game presentations, generate scatter game payouts, and/or display any data relating to the scatter game.

Persistent state evaluation module 438 (e.g., persistent module 422) may evaluate one or more outcomes for one or more events relating to persistent state game play. Further, persistent state evaluation module may determine one or more outcomes of one or more interactions.

Advertisement module 428 may generate, compile, transmit, and/or store advertisement information relating to one or more persistent states, subscription based progressive, and/or any other gaming feature. These advertisements may be presented on one or more display screens, an internet website, and/or any other advertisement avenue.

Subscription-based progressive module may generate, compile, transmit, and/or store one or more subscription based progressive structures and/or any other data relating to one or more subscription based progressive structures and/or subscription based persistent state game play.

3D gesturing module may generate, compile, transmit, and/or store one or more data points, presentations, reference modules, and/or structure relating to any aspect of 3D gesturing.

Pseudo module may generate, transmit, compile, and/or store one or more data points and/or presentations relating to one or more pseudo gaming options and/or pseudo gaming wagers.

Skill-based module may generate, compile, store, and/or transmit one or more skill-based structures and/or one or more skill-based tournament structures. Skill-based evaluation module may evaluation one or more outcomes of one or more skill-based games and/or skill-based tournament games.

Mobile device module 434 may generate, compile, store, and/or transmit one or more data relating to the mobile device. Further, mobile device module 434 may interact and communicate with mobile device to transfer and/or receive data from and/or to mobile device.

Game configuration module 436 may generate, compile, store, and/or transmit one or more game configuration data. Further, mobile device may also include a game configuration module.

Installation verification module may verify the installation parameters on one or more of audio devices, one or more display devices, one or more electrical wires, one or more springs, one or more motors, one or more adjustable devices, and/or one or more sensors to one or more reference data points. Installation verification module may generate a warning when the data points are outside of a specific parameter range. One or more warnings may be transmitted to an external device, a server, a mobile device, and/or a warning display on electronic gaming device 100 based on the verification data.

Locking module may control the locking mechanism for one or more audio devices, one or more display devices, one or more electrical wires, one or more springs, one or more motors, one or more adjustable devices, and/or one or more sensors. Locking module may control any locking mechanism for electronic gaming device 100. Locking module may generate a warning when a locking data point is outside of a specific parameter. These warnings may be transmitted to an external device, a server, a mobile device, and/or a warning display on electronic gaming device 100.

It should be noted that one or more modules may be combined into one module. Further, there may be one evaluation module where the determined payout does not depend on whether there were any wild symbols, scatter symbols, treasure based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

In one embodiment, a system, device, and/or method may offer bets that are dependent on a function of a primary slot machine and/or any other device. For example, a second window may open on a primary game screen (and/or any other display and/or any other output device) that offers a wager on the outcome of the next game (e.g., spin, etc.). In one example, the wagering option may be whether the next game (e.g., spin, etc.) will be a winner or a loser. The player may make the wager and play the game. If the results of the game play is consistent with the player's bet, the player wins and is awarded a prize. In one example, the gaming system does not determine the outcome of the future game play before the wager and/or odds are accepted and/or created. In this example, this gaming option may not need to be approved as a gaming device and may not be subject to the rigorous standards of a regulated gaming device. In this example, an accounting system that accepts bets and pays winning bets may be utilized. In these examples, the player is betting on some characteristic of slot machine play and/or another verifiable event outcome.

In one example, the types of wagers that can be accepted are not relegated to the outcomes of the player's slot machine. In various examples, the possibilities for betting options are related to the events and/or occurrences that can be observed, recorded, and/or verified by the system. For example, one wagering option may be whether the progressive jackpot will be triggered and/or hit in the next 3 minutes and/or next 10 spins. In another example, one wagering option may be whether another person (e.g., a friend, a wife, a husband, a stranger, etc.) will win on the next spin. In this example, a loyalty card (and/or some other identification method) may be utilized to identify the player and/or a specific gaming device identification number may be utilized. In another example, one wagering option may be whether the mystery progressive will be hit (e.g., won) before it reaches a certain number (e.g., $300, $1,000, etc.).

In another example, the credits for the wager and the winnings may be moved to and from the primary gaming device through automatic fund transfer (“AFT”) transactions from the system. Further, the system may act as the book maker for the bets. The system may meter and account for all transfers in total and by each game in which pseudo wagers have been made.

In another example, the system may determine the one or more event outcomes via SAS communications, communications with a class II server, and/or other communication protocol and/or other forms of communication methods. The system may record one or more outcomes for the wager and relays the results to the player and/or one or more EGMs. In addition, the system may allow for a ticket to be printed as a pseudo wager receipt but this may not be necessary as the pseudo wager information is already stored on the system. In addition, in cases where the pseudo wager cannot be completed, the pseudo wager may be returned to the player or to the player's account. In various examples, one or more rules may be implemented for pseudo wagers that depend on an event occurring over a time period and/or as other events happen to prevent the player from trying to cancel wagers as a limit is approached. For example, a player may want to cancel a bet that the next four spins will be winner once the second spin was not a winner. However, the system may not allow this.

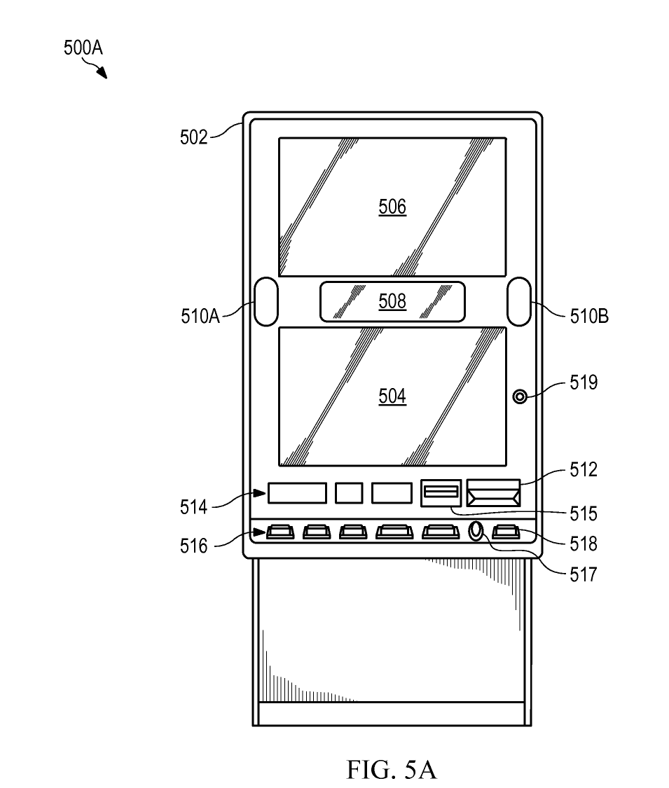

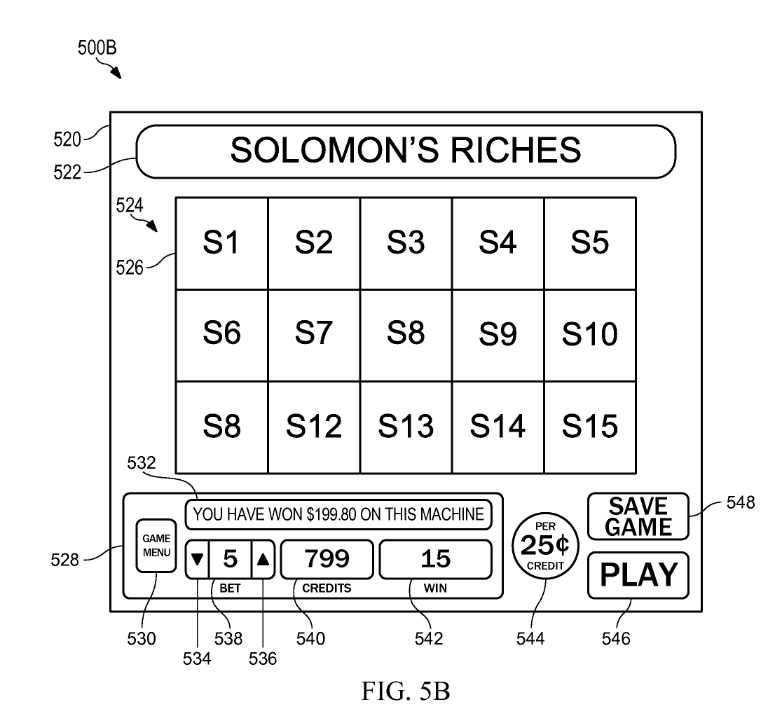

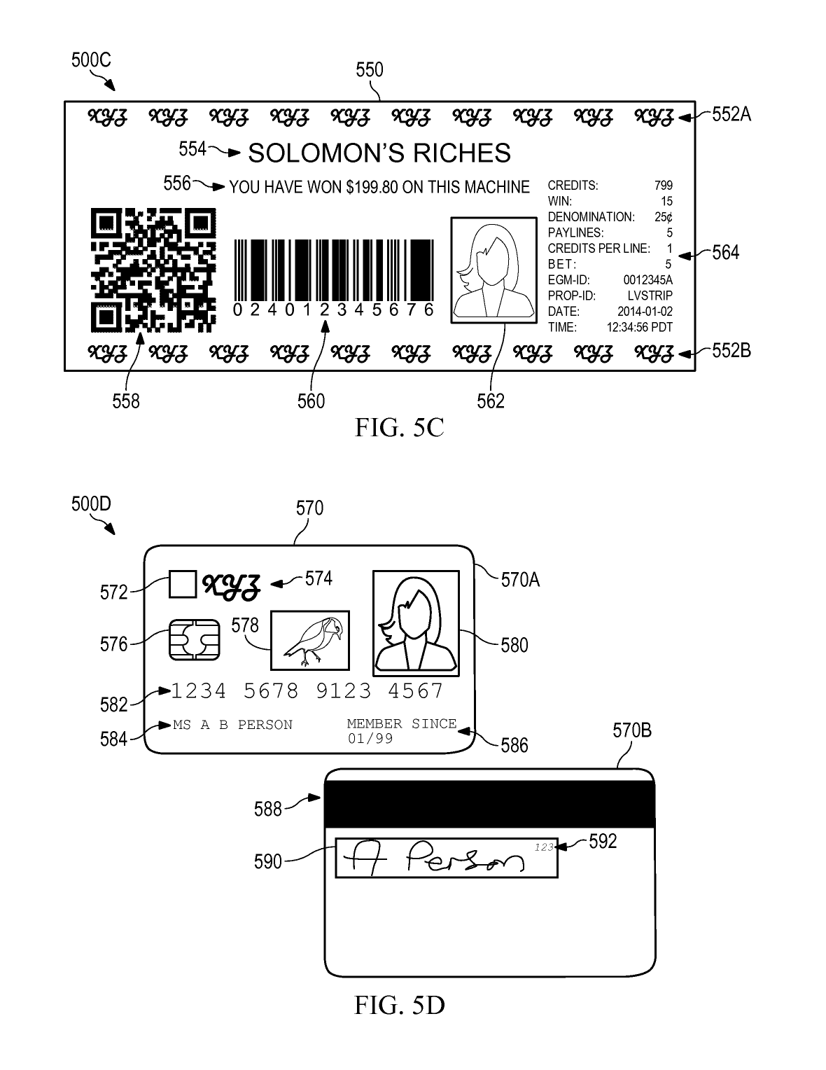

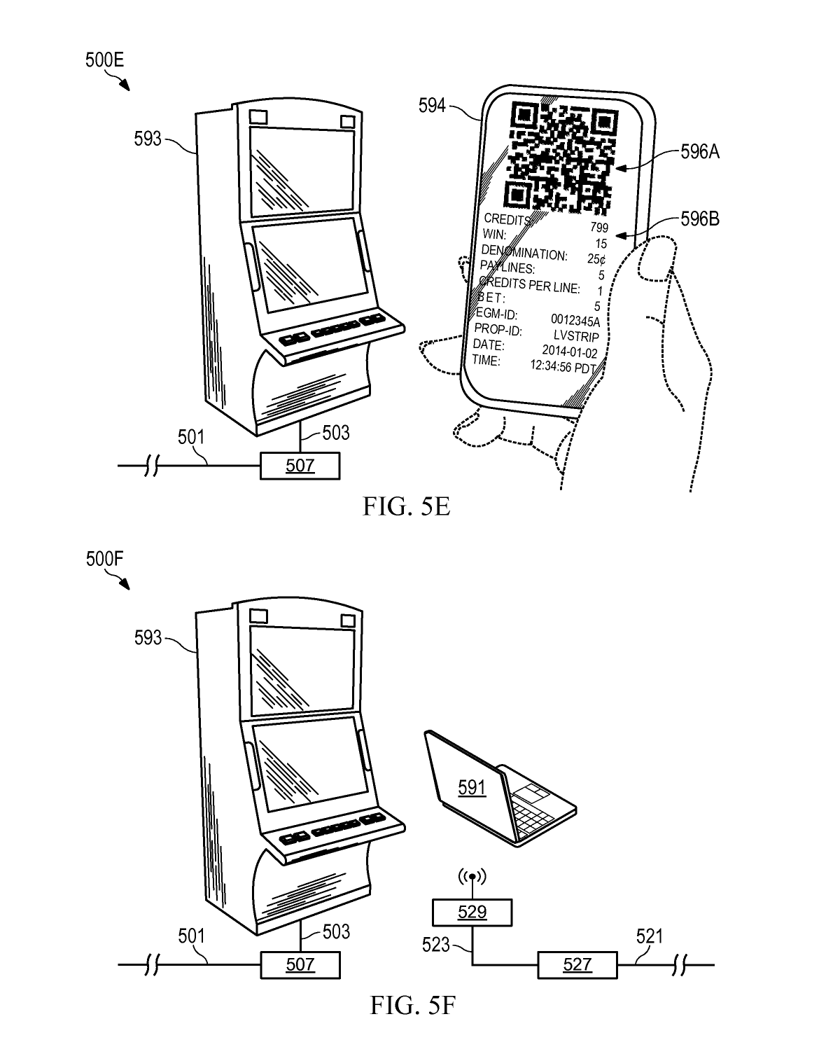

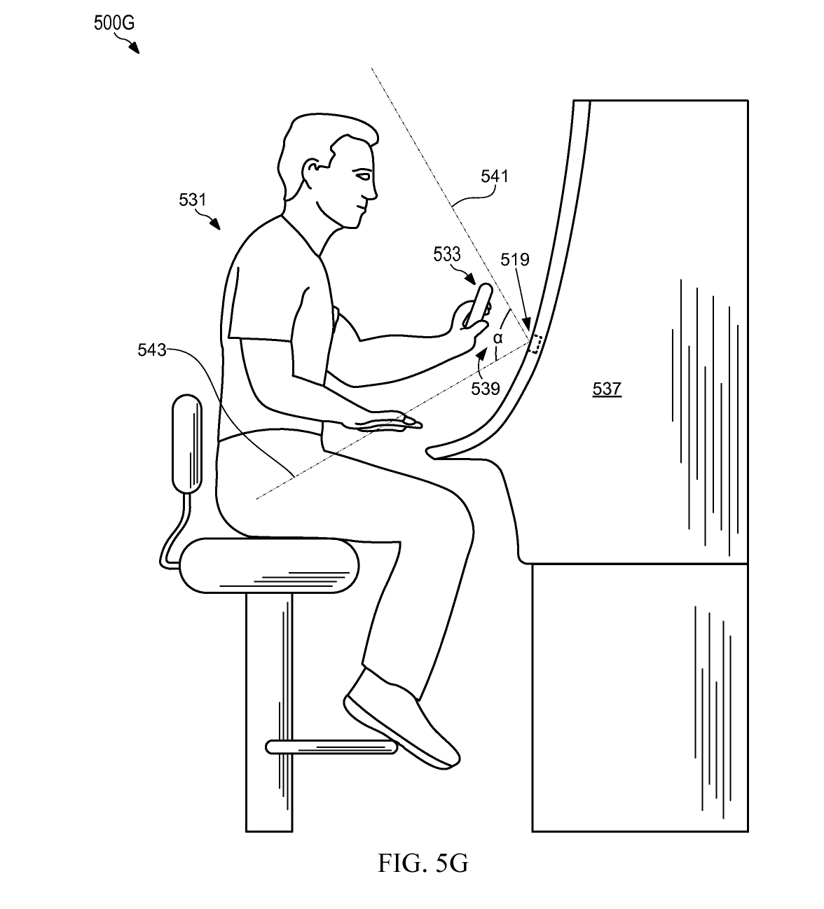

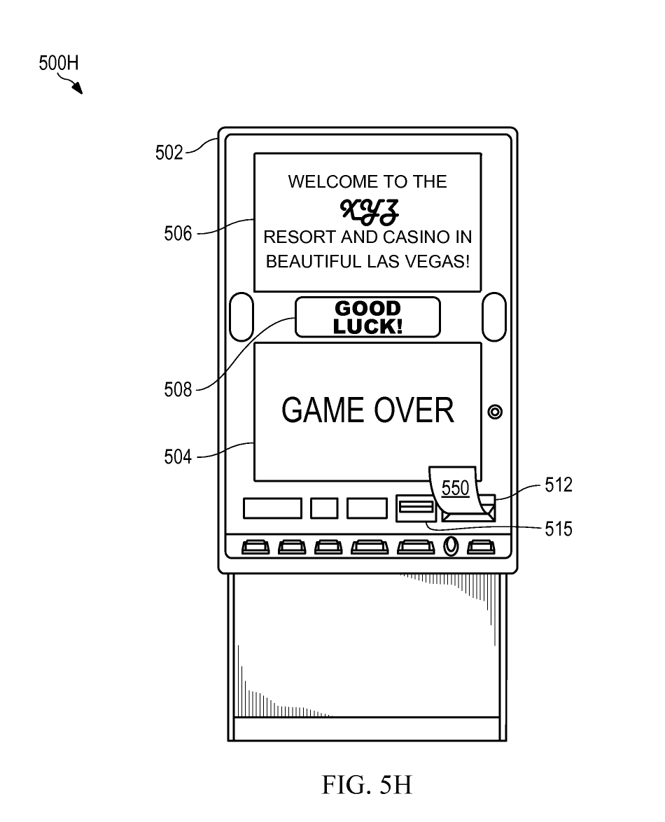

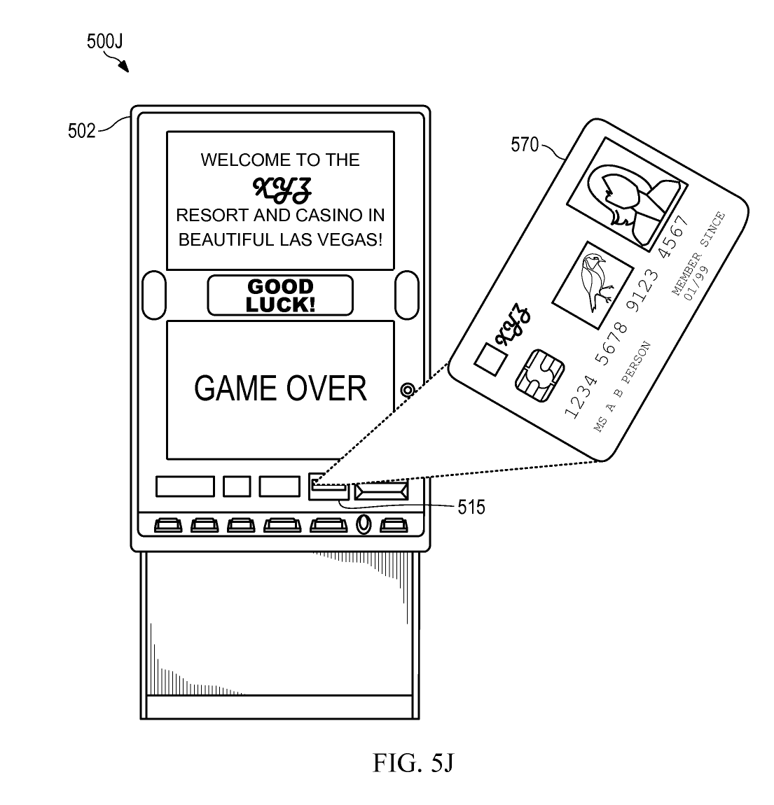

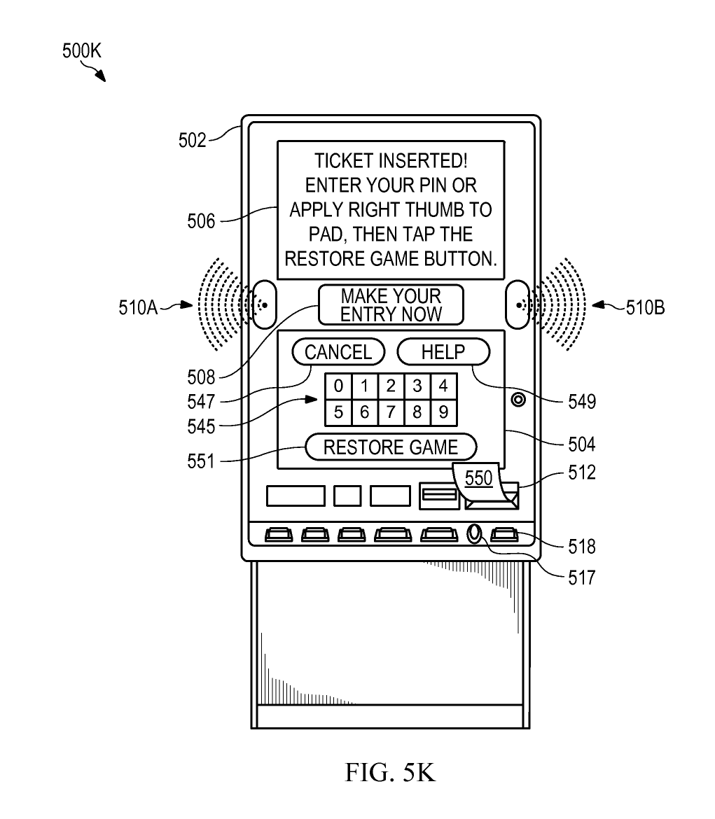

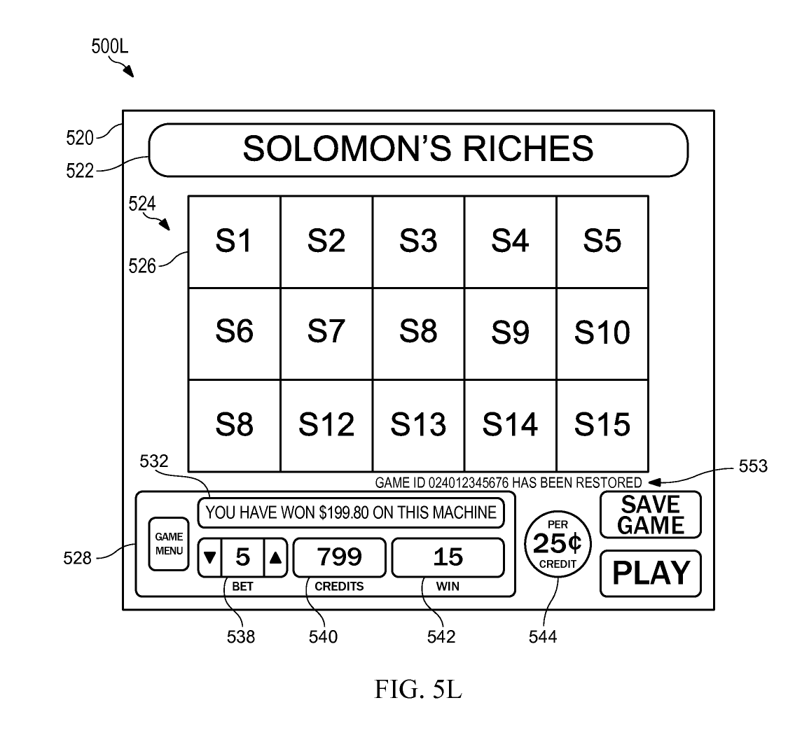

In FIG. 5A, an illustration of a gaming device cabinet 500 is shown, according to one embodiment. A gaming device 502 may include an overhead display 506, a side display 508, a main game display 504, a left speaker 510A, a right speaker 510B, one or more output devices (e.g., a ticket in/ticket out device 512), and/or one or more input devices 516 (e.g., buttons, bill validators, etc.). In one example, overhead display 506 includes a leadership board sponsor and/or a ranking of tournament players. In this example, the XYZ company has sponsored the leadership board and the leadership board states “XYZ LEADER BOARD.” In another example, leadership display may include data relating to one or more tournaments, such as, the time remaining (e.g., 1 HOUR 31 MINUTES REMAINING). In this example, side display 508 may display a current mode of operation. For example, a current mode may be a tournament mode, a normal mode, a practice mode, a team mode, an individual mode, any combination thereof, etc. In this example, gaming device 502 may include an output area 514, a persistent state output device 515 (the persistent state output device 515 may be independent and/or combined with ticket in/ticket out device 512), a persistent state activation device 517, a persistent state voice activated device 518, and a persistent state motion activation device 519.

Persistent state output device 515 (the persistent state output device 515 may be independent and/or combined with ticket in/ticket out device 512) may generate one or more forms (e.g., a ticket, a magnetic card, etc.) to be utilized as a reference for persistent game play functionality. In one example, these forms may be utilized to restart one or more game play functions after a break from playing the electronic gaming machine at the same point the break in the game play occurred.

Persistent state activation device 517 may initiate one or more persistent state gaming functionality. For example, the persistent state activation may be initiated via a mechanical button.

Persistent state voice activated device 518 may initiate one or more persistent state gaming functionality via a voice command. For example, the persistent state activation may be initiated via a voice command, such as, initiate persistent state game play and/or save game play.

Persistent state motion activation device 519 may initiate one or more persistent state gaming functionality via a motion gesture. For example, the persistent state activation may be initiated via a gesturing motion, such as, arm wave, head nod, etc. Further, any of these functions (e.g., mechanical button, voice command, motion gesturing, etc.) may be combined to initiate one or more persistent state gaming functionality.

In FIG. 5B, an illustration of a persistent state game play on a gaming device is shown, according to one embodiment. A first image 500B may include a display screen 520, a game title area 522, an active game area 524, one or more reels 526, a game data area 528, a game menu button 530, a message area 532, a bet area (e.g., a decrease bet button 534, a bet amount 538, and an increase bet button 536), a credit balance amount area 540, a winning amount area 542, a credit amount 544, a persistent state initiation button 548 (e.g., save game button), and a play button 546.

In FIG. 5C, an illustration of persistent state game play on a gaming device is shown, according to one embodiment. A second image 500C may include a ticket 550 where ticket 550 may be made of paper, plastic, and/or any other material. Ticket 550 may include a first sponsor area 552A, a second sponsor area 552B, and an Nth sponsor area (not shown). Ticket 550 may include a game title area 554, a message area 556, a QR code area 558, a bar code area 560, a player image area 562, and a game data area 564.

First sponsor area 552A may be a third party which may want to advertise a product. For example, a car dealer may sponsor the card and advertise that their prices will not be beat. In addition, second sponsor area 552B may be a poker tournament company. Further, any number of sponsors may be utilized (e.g., 1 to Nth sponsor area).

Game title area 554 may display the game title for the specific game in which the persistent game play function was initiated. Further, game title area 554 may list those game titles in which the persistent game play functions can be reinitiated (e.g., game title 1 to game title N).

Message area 556 may state any message relating to game play, persistent game play, and/or any other information. QR code area 558 may include any data relating to the QR code. Bar code area 560 may include any data relating to the bar code. Player image area 562 may include any data relating to the player's image and/or the player's image. In one example, the electronic gaming device may compare the image on the ticket with the image of the person trying to play the game to confirm that they are the same person. Game data area 564 may include any data (e.g., credits per payline, credit balance, paylines, etc.) relating to game play.

In FIG. 5D, an illustration of persistent state game play on a gaming device is shown, according to one embodiment. A third image 550D may include a magnetic card 570 where magnetic card 570 may include a first side 570A and a second side 570B. First side 570A may include a casino logo area 572, a sponsor area 574, an EMV chip 576 (e.g., an integrated circuit card), a hologram area 578, a player image area 580, a card number 582 (e.g., a player tracking number), a name area 584, and a membership data area 586. Second side 570B may include a magnetic stripe area 588, a signature area 590, and a card security code area 592.

Casino logo area 572 may include any logo information relating to one or more casinos. Sponsor area 574 may include any data relating to one or more sponsors. EMV chip 576 (e.g., an integrated circuit card) may be utilized to enhance security. Further, hologram area 578, player image area 580, card number 582 (e.g., a player tracking number), name area 584, and/or membership data area 586 may be utilized to enhance security and/or one or more marketing functions. Second side 570B may include magnetic stripe area 588, signature area 590, and card security code area 592 to enhance security functions.

In FIG. 5E, another illustration of persistent state game play on a gaming device is shown, according to one embodiment. A fourth image 500E may include a gaming device 593 connected via one or more links 503 (e.g., CAT 5 cables, etc.) to an Ethernet switch 507 where the Ethernet switch 507 is connected via one or more links 501 to one or more back-end servers. In this example, these connections connect the electronic gaming device to the casino's back office where there is equipment for interfacing with the public switched telephone network and/or cellular network (e.g., GMS). In this example, a mobile device 594 may have data relating to game play transferred to it from the electronic gaming device. Mobile device 594 may display a QR code 596A and game data 596B.

In another example shown in FIG. 5F, the gaming data and/or the QR code may be transferred to a laptop computer 591. In this example, a wireless access point 529 (e.g., WAP) may be located within the casino. Further, an Ethernet switch 527 may be utilized with one or more links (e.g., reference numbers 521 and 523).

In FIG. 5G, another illustration of persistent state game play on a gaming device is shown, according to one embodiment. A fifth image 500G may include one or more sensors 519, a player image 531, a mobile device 533, and an electronic gaming device 537. The one or more sensors 519 may sense a field from a first border 541 to a second border 543 within a first angle 539. In this example, the system, device, and/or method may read the persistent data via the smart phone, the sensors, and/or one or more interactions between the smart phone and/or sensors. In addition, for authentication, the camera and/or sensors may be used for biometric facial recognition. In various examples, photo images, biometric data (e.g., finger prints, etc.), PIN numbers, and/or player movements may be utilized with this disclosure.

In FIG. 5H, another illustration of persistent state game play on a gaming device is shown, according to one embodiment. A sixth image 500H may include electronic gaming device 502 with a first display screen 506, a second display screen 508, and a third display screen 504. Further, the TITO device 512 may print out a ticket 550 which may include persistent data and/or payout information and/or credit information and/or game data and/or game configuration data.

In FIG. 5J, another illustration of persistent state game play on a gaming device is shown, according to one embodiment. A seventh image 500J may include electronic gaming device 502 with a magnetic card input device 515 where a magnetic card 570 may be inserted. In one example, the TITO function and the persistent state gaming function may be combined.

In one example shown in FIG. 5K, by inserting the magnetic card 570 which includes persistent data (e.g., saved data, etc.) into the electronic gaming device 502, the previously saved gaming configuration may be restored. For example, a message area 506 may state “TICKET INSERTED! ENTER YOUR PIN OR APPLY YOUR RIGHT THUMB TO PAD, AND THEN TAP THE RESTORE GAME BUTTON.” In one example, a second message area 508 may request that the player make an entry now. Further, a PIN pad 545 may be displayed. In addition, a cancel button 547, a help button 549, and restore game session button 551 may be shown. In one example, to reestablish game play the electronic gaming device may request that the player enter a PIN number, complete a voice recognition procedure, utilize their image, and/or biometric data (e.g., finger print, etc.).

In another example shown in FIG. 5L, the restored gaming session is shown. In this example, a restore session message 553 may state “GAME ID 024012345676 HAS BEEN RESTORED.” Please note that the restored gaming session shown in FIG. 5L is exactly the same the gaming session shown in FIG. 5B except for the restored session message 553. In one example, the exact same game is reestablished.

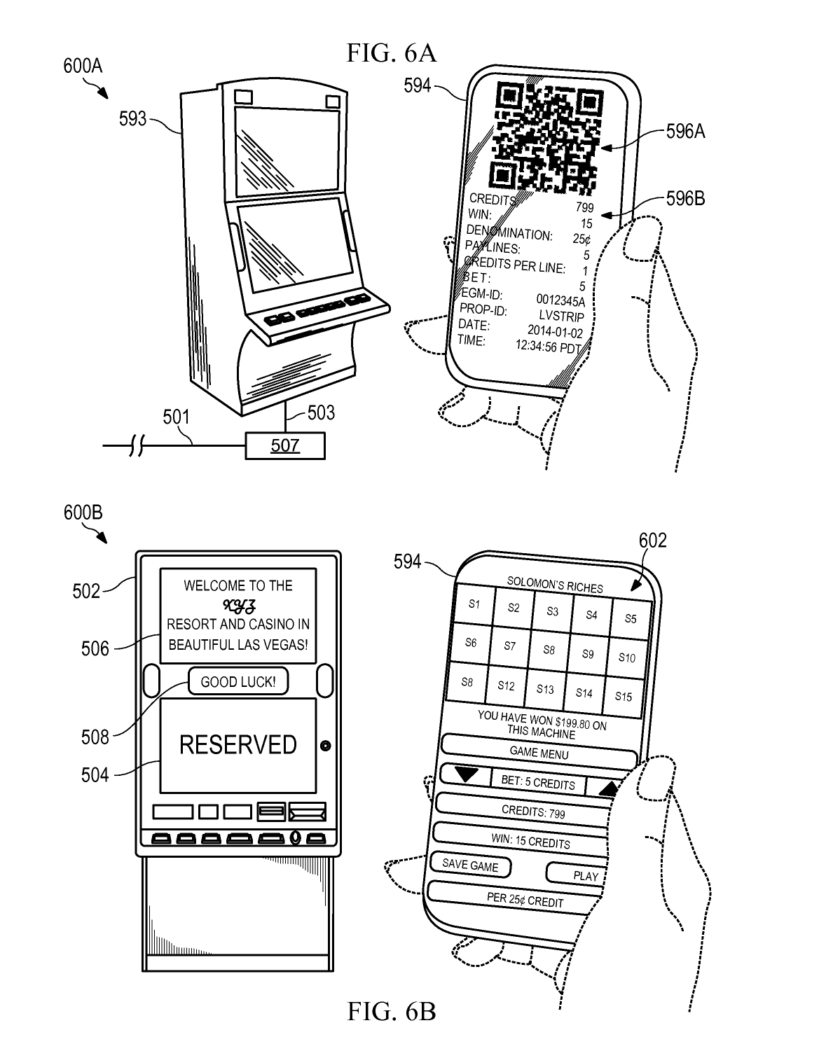

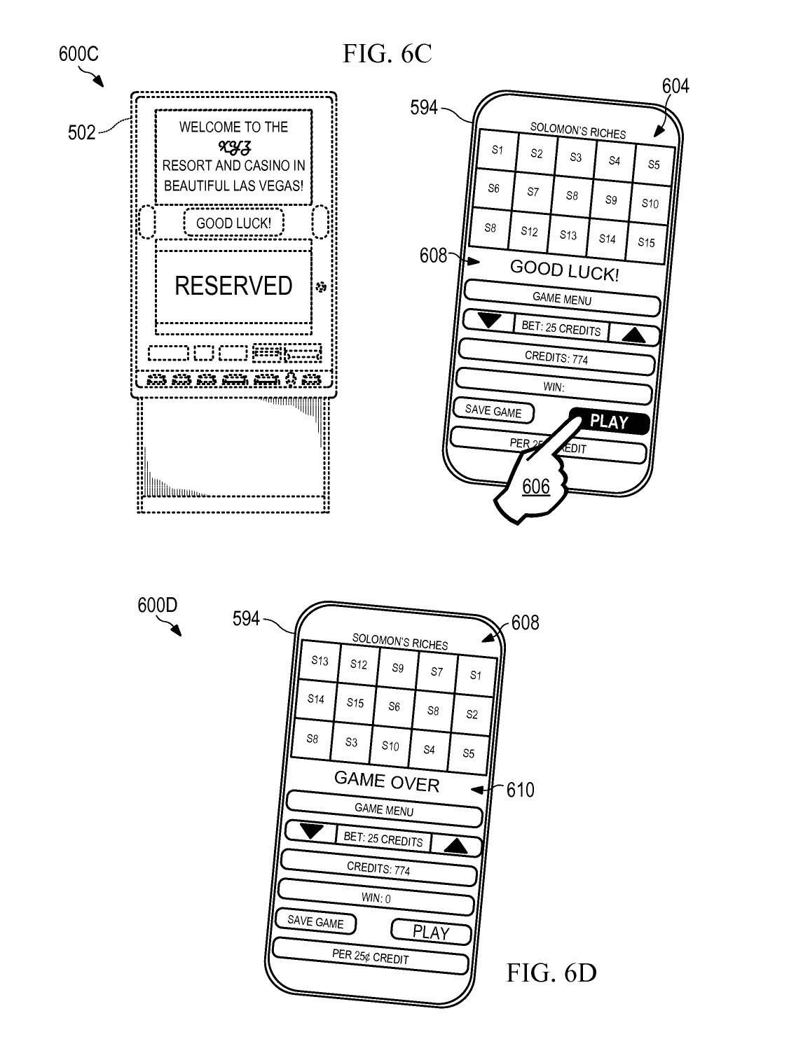

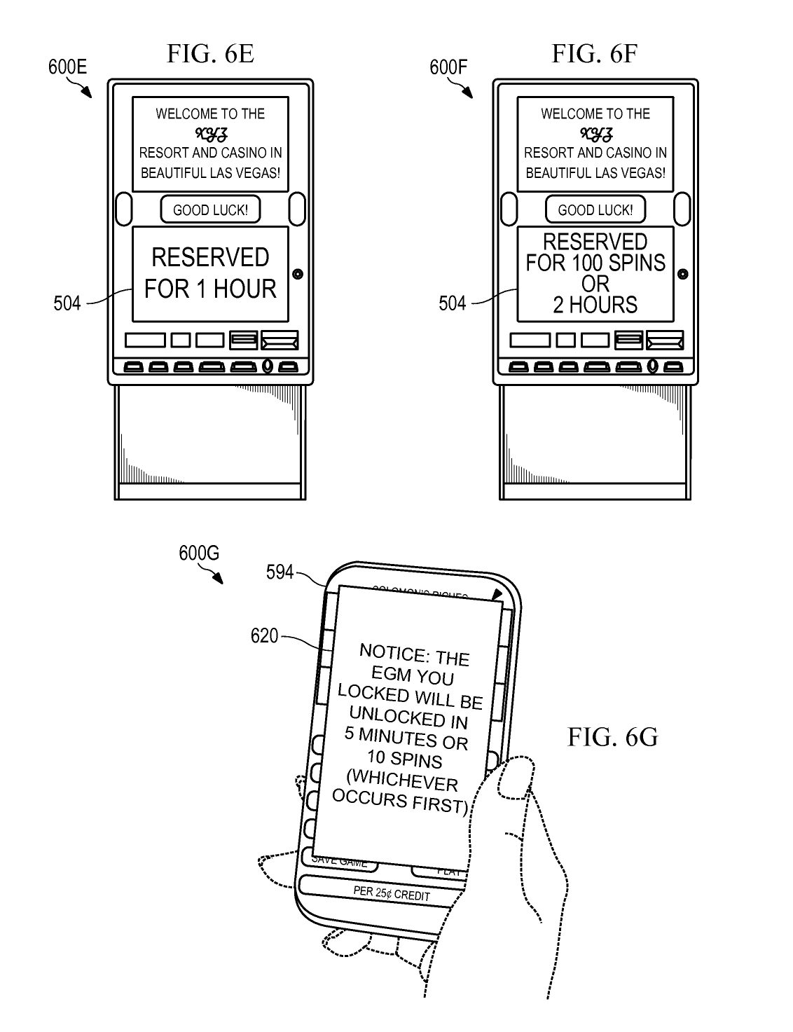

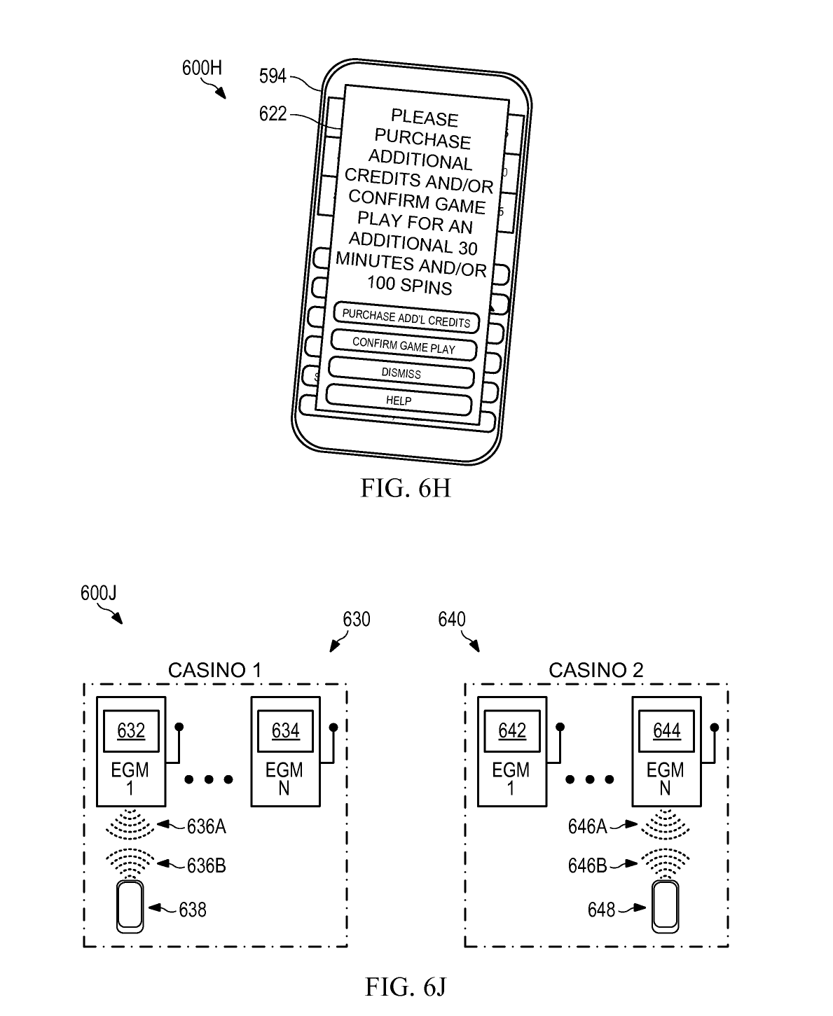

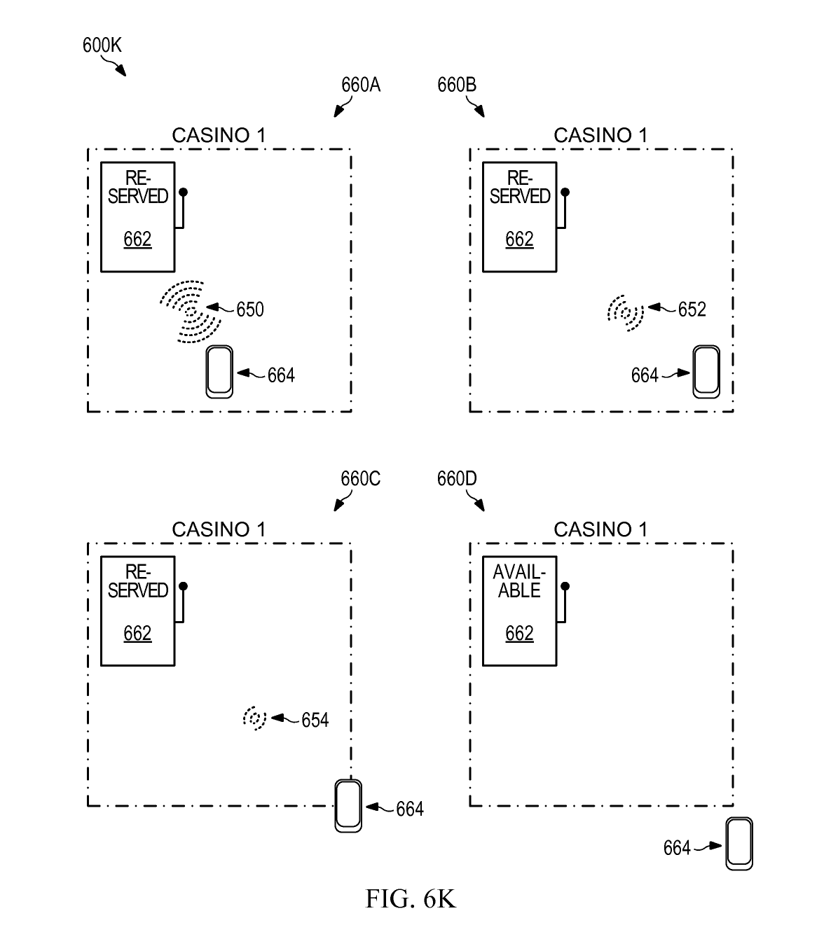

In FIG. 6A, another illustration of persistent state game play on a gaming device is shown, according to one embodiment. A persistent state image 600A may include gaming device 593 connected via one or more links 503 (e.g., CAT 5 cables, etc.) to Ethernet switch 507 where the Ethernet switch 507 is connected via one or more links 501 to one or more back-end servers. In this example, these connections connect the electronic gaming device to the casino's back office where there is equipment for interfacing the public switched telephone network and/or cellular network (e.g., GMS). In this example, mobile device 594 may have data relating to game play transferred to it from the electronic gaming device. Mobile device 594 may display a QR code 596A and game data 596B.

In this example shown in FIG. 6B, a game configuration 602 may be transferred to mobile device 594. In this example, one or more game play data may be transferred to mobile device 594. For example, one or more reels, one or more message areas, one or more game menus, one or more credit data, one or more credit amounts, one or more winning information, a save game button, a play game button, and/or one or more credit amounts (e.g., per 25 cents per credit). In this example shown in FIG. 6C, game play may be transferred to mobile device 594. Further, game play may be initiated on mobile device 594. One or more game plays may be initiated on mobile device 594 via game play start button 606. In this example, a message area 608 on mobile device 594 may state “GOOD LUCK!” In this example, the results of game play may be shown on mobile device 594 (see FIG. 6D) and/or on electronic gaming device 502. The gaming results may be shown on electronic gaming device 502 independent of whether the player is located near the electronic gaming device 502. For example, the electronic gaming device 502 may initiate one or more game plays when the player is taking a break and not near the electronic gaming device. These game plays may occur on just the electronic gaming device 502 or these game plays may occur on just the mobile device 594 or these game plays may occur on both the electronic gaming device 502 and the mobile device 594 and/or occur inside of either device and are not displayed and/or the end results of all of the random numbers which were generated.

In FIG. 6E, another illustration of persistent state game play on a gaming device is shown, according to one embodiment. A first image 600E may include electronic gaming device 502 with a reservation message 504 which states “RESERVED FOR 1 HOUR.” In another example shown in FIG. 6F, reservation message may state “RESERVED FOR 100 SPINS OR 2 HOURS”.

In FIG. 6G, another illustration of persistent state game play on a gaming device is shown, according to one embodiment. The mobile device 594 may notify the player that the electronic gaming device that the player locked up will be unlocked in 5 minutes or 10 spins whichever occurs first. In this example, the player had locked up (e.g., reserved an electronic gaming machine for a predetermined amount of time and/or predetermined amount of spins and/or any other predetermined criteria (e.g., amount lost, amount won, a single winning criteria—the next 1000 credit win, the next bonus game, etc.) the gaming device. The player may receive one or more notifications (e.g., winning notification, losing notification, time left notification, a warning that the reserve gaming session will soon expire notification, etc.).

Once the warning notification (and/or any notification) is issued that the game play session will come to an end based on a predetermined criteria, the player may purchase additional credits to continue game play, select one or more criteria to continue game play, confirm the current game play session, dismiss the notification, end the game play session, and/or request a help function. For example in FIG. 6H, the player may be required to purchase additional credits and/or to confirm game play for an additional 30 minutes and/or 100 spins to continue game play, the game play session, to restore the EGM, and/or to reserve the EGM.

In FIG. 6J, another illustration of persistent state game play on a gaming device is shown, according to one embodiment. In this example, a player may utilizes their mobile device and/or any other transfer function to reload persistent game play data to a first EGM 632 via communication links (e.g., reference numbers 636A and 636B) at a first casino 630. Further, the player may utilize their mobile device and/or any other transfer function to reload persistent game play data to a second EGM 634 at the first casino. In addition, the player may utilize their mobile device and/or any other transfer function to reload persistent game play data to a first EGM 642 at a second casino 640. In addition, the player may utilize their mobile device and/or any other transfer function to reload persistent game play data to a second EGM 644 at a second casino via one or more communication functions (reference numbers 646A and 646B).

In FIG. 6K, another illustration of persistent state game play on a gaming device is shown, according to one embodiment. A persistent image 600K may include a first gaming device 662 which is reserved by the player. The first gaming device 662 may stay reserved as long as the player via a mobile device 664 stays within a communication range of the electronic gaming device. For example, the first gaming device 662 stays reserved because of a first communication field 650, a second communication field 652, and/or a third communication field 654 indicating the player is within a predetermined range. Once there is no communication field and the player and/or mobile device has moved to an out-of-range location 664, the electronic gaming device 662 becomes available and/or unreserved. Further, there may be a time delay period to handle a temporary interruption in the communication signals.

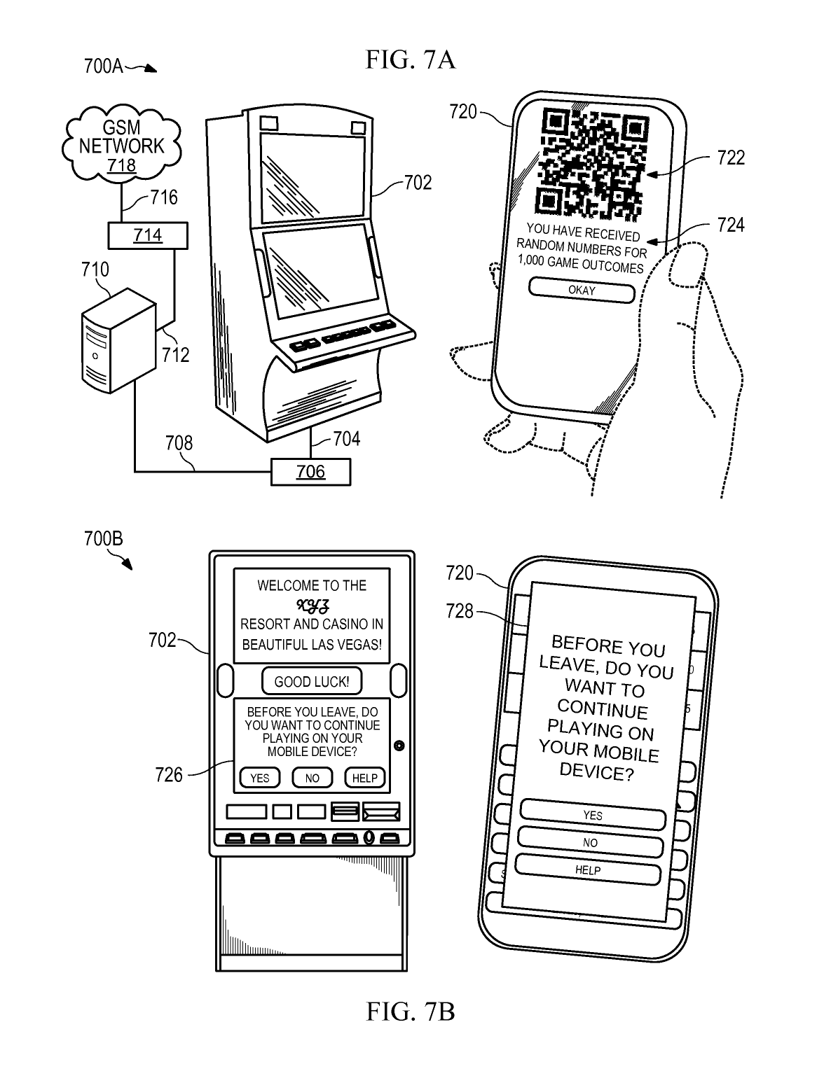

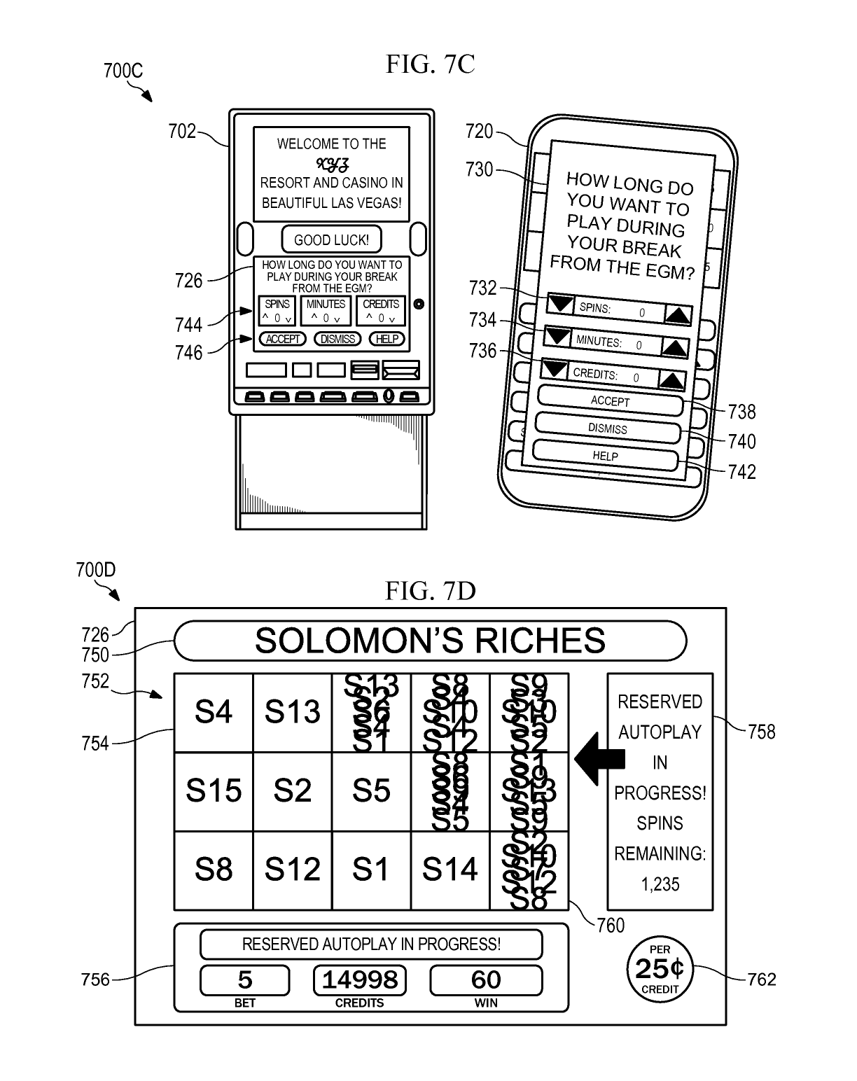

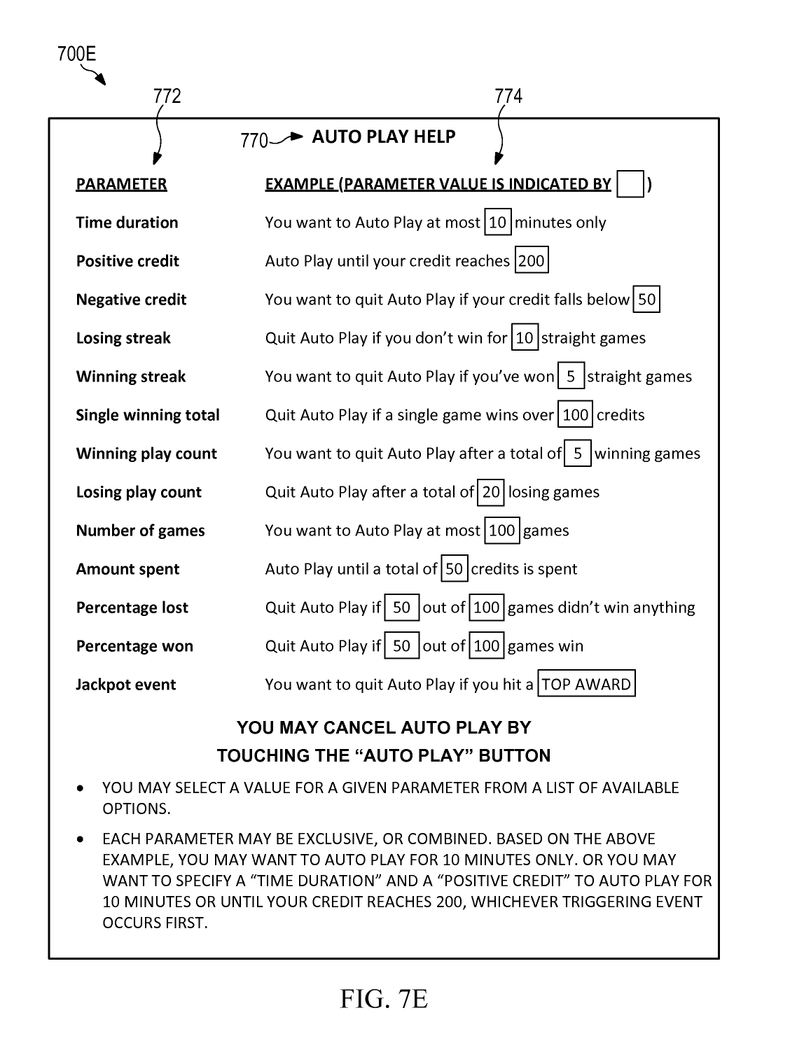

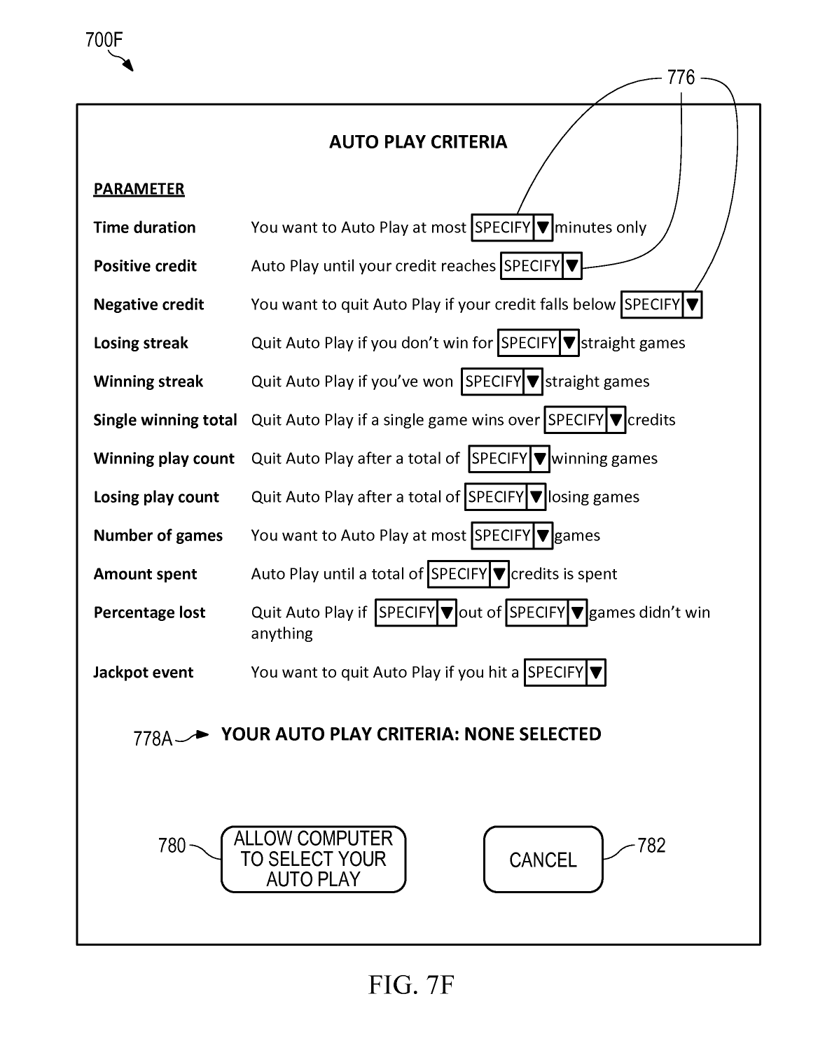

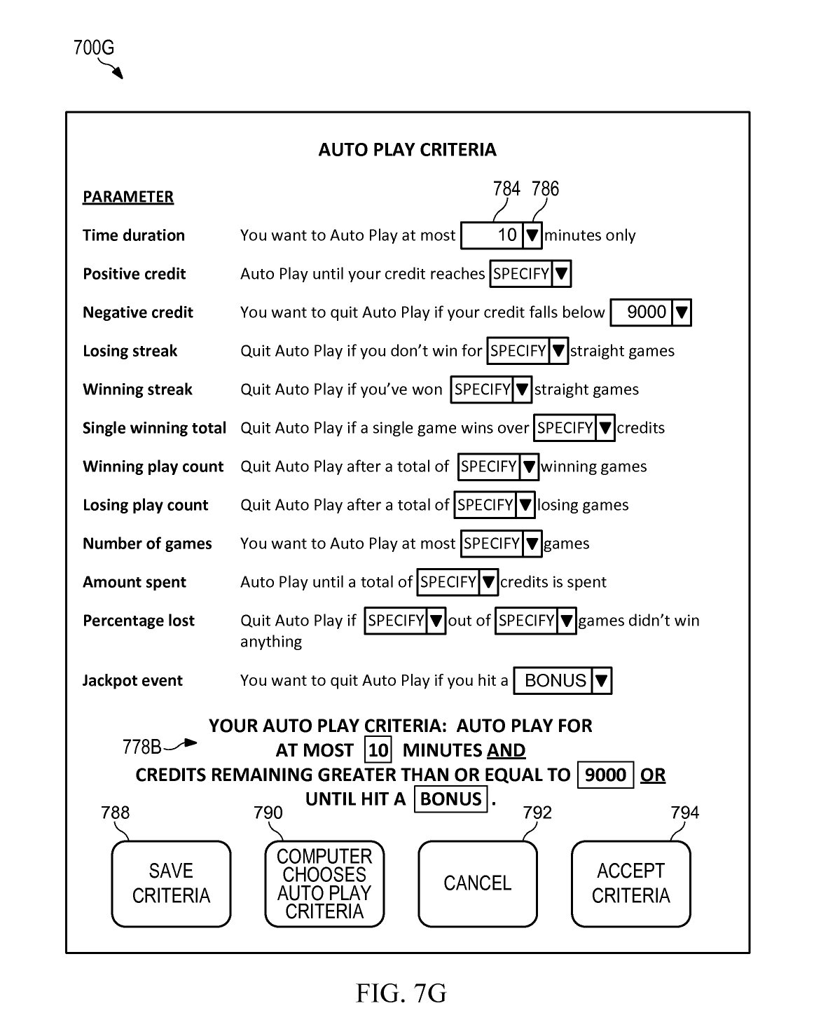

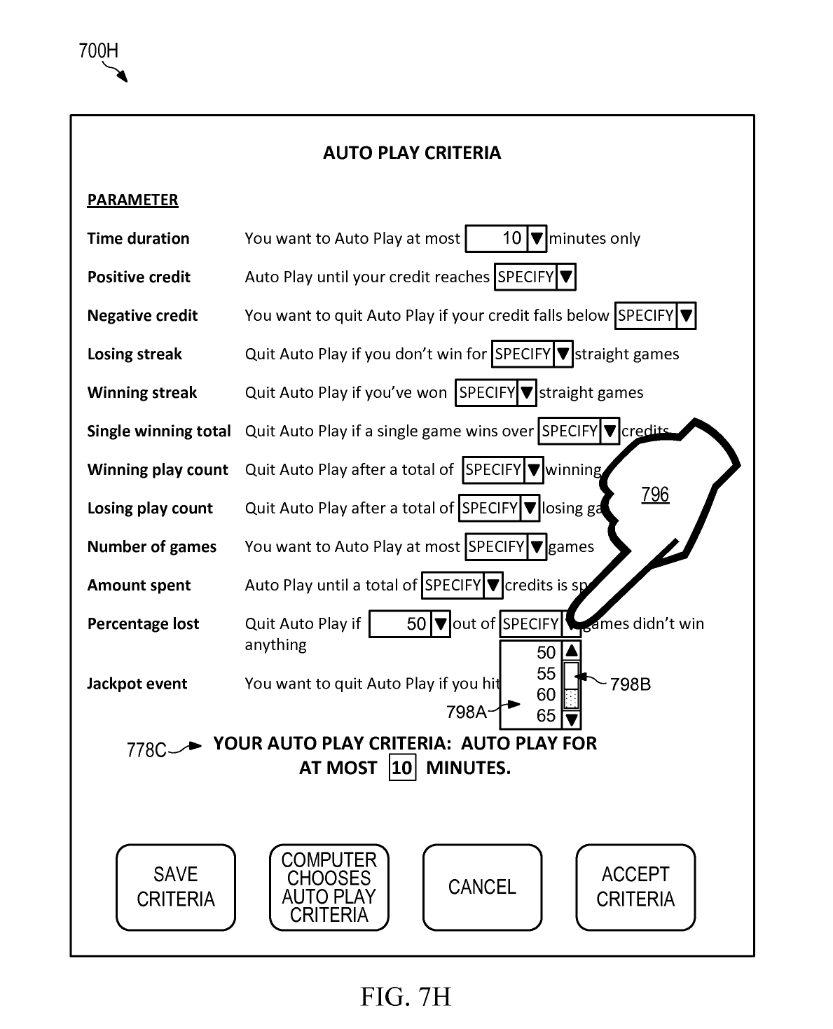

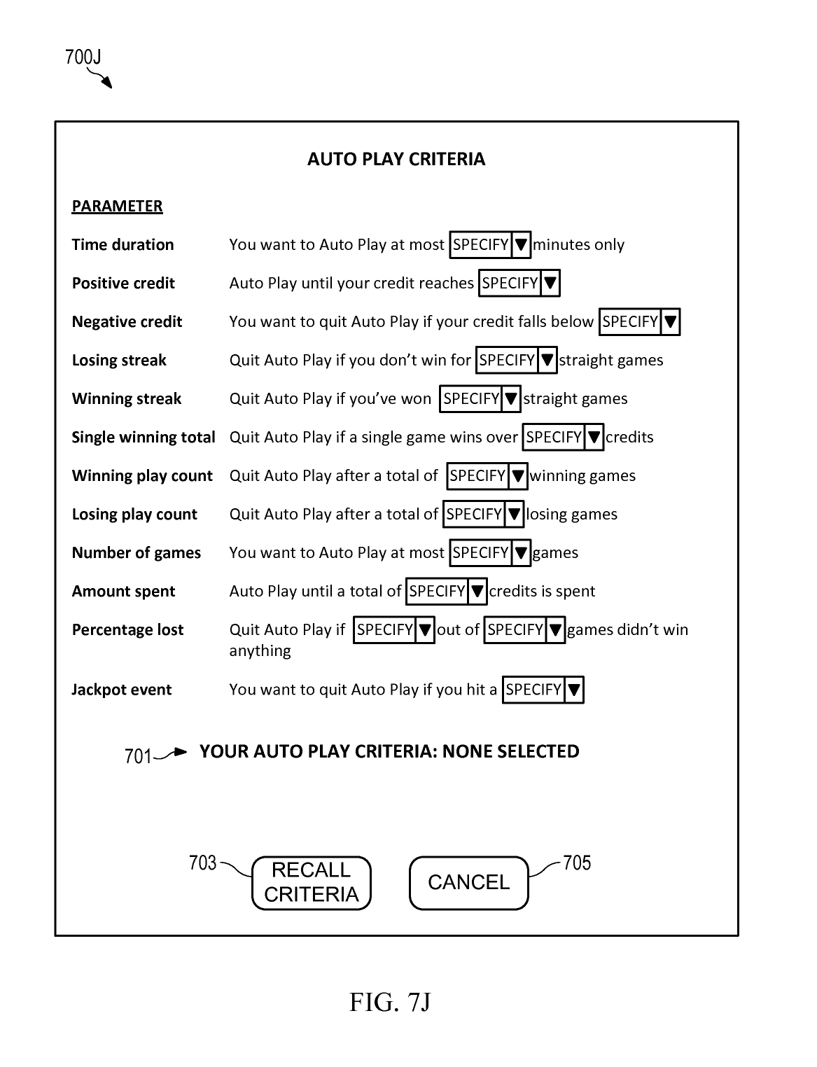

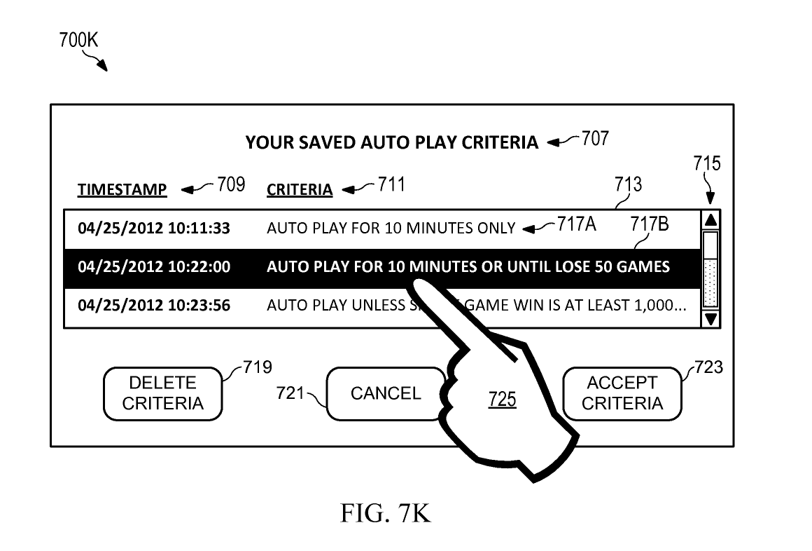

In FIG. 7A, another illustration of persistent state game play on a gaming device is shown, according to one embodiment. A persistent state image 700A may include gaming device 702 connected via one or more links 704 (e.g., CAT 5 cables, etc.) to Ethernet switch 706 where the Ethernet switch 706 is connected via one or more links 708, 712, 716 to one or more back-end servers (e.g., server 710, switch 714, and GSM network 718). In this example, these connections connect the electronic gaming device to the casino's back office where there is equipment for interfacing the public switched telephone network and/or cellular network (e.g., GMS). In this example, mobile device 720 may have data relating to game play transferred to it from the electronic gaming device. Mobile device 720 may display a QR code 722 and game data 724. In this example, game data 724 may include x number (e.g., 1,000 random numbers of gaming outcomes) be transferred to mobile device 720. In this example, these 1000 random numbers are the gaming outcomes (and/or the gaming outcomes are dependent on these random numbers) for the next 1000 games. Further, the player may be required to press an acceptance key. In this example, the game play configuration may be transferred from the EGM to the mobile device.

In another example shown in FIG. 7B, the EGM may ask the player if they want to transfer the gaming configuration to their mobile device by stating “BEFORE YOU LEAVE, DO YOU WANT TO CONTINUE PLAYING ON YOUR MOBILE DEVICE?” In this example, the request may have a confirmation key (e.g., Yes), a cancel key (e.g., No), and/or a help function. In various examples, bonuses, credits, spins, and/or any other reward may be offered to the player to continue game play, select persistent game play options, and/or any combination thereof. For example, when the player attempts to leave the EGM may state that if the player selects a persistent gaming options, that the player will receive an additional 10 credits, 5 free spins, 10% credit bonus, etc.

In another example shown in FIG. 7C, the EGM may ask the player about the criteria around their break from the EGM. For example, the player may select the number of spins, the minutes, the credits, and/or any other criteria relating to persistent state game play and/or an auto play function.

In an example shown in FIG. 7D, the game configuration is shown on either the mobile device and/or the EGM utilizing either an auto play functionality and/or a reserved EGM game functionality.

FIG. 7E and FIG. 7F are illustrations of persistent state game play on a gaming device, according to various embodiments. An auto play help image may include one or more parameters and/or one or more examples 776 (e.g., parameter value is indicated by). One example may be if a player wants to set a parameter for a time duration of auto-play to at most 10 minutes. The player may choose any amount of time (e.g., 1 minute, 5 minutes, 10 minutes, 30 minutes, 1 hour, 5 hours, etc.). Another example may be if a player wants to change the parameter relating to positive credits. The auto-play functionality may continue until the player's credits reach a certain chosen amount (e.g., 1, 50, 100, 200, 300, 500, 1000, etc.). Another example may be if a player wants to change the negative credit parameter. The player may select that auto-play mode turns off after his/her credits fall below a certain amount (e.g., 1, 10, 20, 40, 50, 100, 1000, etc.). Another parameter a player may change may be related to a losing streak. For example, the auto-play functionality may be ended if the player does not win for a set amount of straight games (e.g., 1, 5, 10, 15, 20, 30, 50, etc.). Another parameter a player may manipulate may be related to a winning streak. For example, a player may decide to have auto-play functionality turn off after winning a set number of games in a row (e.g., 1, 5, 10, 40, 50, etc.). In another example, a player may want to set a single winning total amount. This option may turn off the auto-play functionality after a certain number of total winning games (e.g., 1, 5, 10, 15, 20, 50, etc.) are achieved. A player may also want to set the single winning total amount. This option may turn off the auto-play functionality after a single game wins over a certain number of credits (e.g., 1, 10, 50, 100, 200, 500, 1000, etc.). A player may want to set the winning play count amount. This option may turn off the auto-play functionality after a certain total of winning games is achieved (e.g., 1, 5, 10, 15, 20, 50, etc.).

In another example, a player may want to set the losing play count. This option may turn off the auto-play functionality after a certain total of losing games had occurred (e.g., 1, 5, 10, 15, 20, 50, etc.). A player may want to have the auto-play functionality turn off after a certain number of games had been played (e.g., 1, 5, 10, 20, 50, 100, etc.). A player may want to have the auto-play functionality turn off after a certain amount of credits have been spent (e.g., 1, 5, 50, 100, 200, 500, 1000, etc.). A player may want to have the auto-play functionality turn off after a certain percentage lost (e.g., 50 out of 100, 40 out of 60, 3 out of 9, etc.). A player may want to have the auto-play mode turn off after a certain percentage of games have been won (e.g., 50 out of 100, 40 out of 60, 3 out of 9, etc.). A player may want to select the jackpot parameter. This may turn off the auto-play functionality after a certain award has been achieved (e.g., top award, double bonus, triple bonus, progressive, etc.). The auto-play help screen may state that a player may click the auto-play button at any time to turn off the auto-play mode. There may be a verification request to ensure that the player wants to cancel auto-play. For example, do you want to cancel auto-play, if so please press the auto-play button again may be shown on a display. The auto-play help image may explain that a player may select a value for a given parameter from a list of available options. Each parameter may be exclusive, or combined (e.g., A player may combine the auto-play functionality parameters of auto-play continuing for 10 minutes only with the auto-play stopping after the player's credit reaches 200 option. The player may select if they want both criteria to happen before the auto-play turns off, if they want only one to happen before the auto-play turns off, or if they want electronic gaming device 100 and/or electronic gaming system 200 to decide if the criteria should both be met, one met, or a combination of factors before stopping auto-play mode). Electronic gaming device 100 and/or electronic gaming system 200 may select any number of criteria (e.g., 1, 2, 5, 10, etc.) to play together, exclusively, or in some predetermined way. For example, electronic gaming device 100 and/or electronic gaming system 200 may combine the auto-play functionality parameters of auto-play continuing for 10 minutes only with the auto-play stopping after the player's credit reaches 200 option, and with the auto-play continuing until the player has won five games. Electronic gaming device 100 and/or electronic gaming system 200 may be set by the casino or manufacturer to select criteria in a certain order based on the player's identification card, randomly, using the player's history, by a predetermined pattern, shuffle, any combination thereof, and/or any other selection method.

FIG. 7G is another illustration of persistent state game play on a gaming device, according to one embodiment. A second image 700G may include an auto-play criteria, parameters 784 (e.g., an example of each parameter—10), one or more drop-down menus 786, a selected criteria, a save criteria button 788, a computer select auto-play button 790, a cancel button 792, and an accept criteria button 794. Auto-play criteria may be a menu of options a player may choose from in order to adapt their auto-play functionality experience. Any combination of parameters may be selected for play. Parameters 784 may include one or more of a time duration, a positive credit, a negative credit, a losing streak, a winning streak single winning total, a winning play count, a losing play count, number of games, an amount spent, a percentage lost, and/or a jackpot event. One or more drop-down menus 786 may represent a pull-down menu, a fill-in area, a voice-recognition box, and/or any other data entry image. An example of each parameter 784 may include the player wants to auto-play at most _X_ minutes only (e.g., X=1, 5, 10, 70, 500, 1000, 10000, etc.), auto-play until your credit reaches _X_ (e.g., X=1, 5, 10, 70, 500, 1000, 10000, etc.), you want to quit auto-play if your credit falls below _X_ (e.g., X=1, 5, 10, 70, 500, 1000, 10000, etc.), quit auto-play if you don't win for _X_ straight games (e.g., X=1, 5, 10, 70, 500, 1000, 10000, etc.), quit auto-play if you've won _X_ straight games (e.g., X=1, 5, 10, 70, 500, 1000, 10000, etc.), quit auto-play if a single game wins over _X_ credits (e.g., X=1, 5, 10, 70, 500, 1000, 10000, etc.), quit auto-play after a total of _X_ winning games (e.g., X=1, 5, 10, 70, 500, 1000, 10000, etc.), quit auto-play after a total of _X_ losing games (e.g., X=1, 5, 10, 70, 500, 1000, 10000, etc.), you want to auto-play at most _X_ games (e.g., X=1, 5, 10, 70, 500, 1000, 10000, etc.), auto-play until a total of _X_ credits is spent (e.g., X=1, 5, 10, 70, 500, 1000, 10000, etc.), quit auto-play if _X_ out of _Y_ games didn't win anything (e.g., X=1, 5, 10, 70, 500, 1000, 10000, etc. and Y=2, 3, 4, 9, 15, 50, 100, 500, 5000, etc.), and you want to quit auto-play if you hit a jackpot. The player may select one parameter, any combination of any of the parameters, and/or ask electronic gaming device 100 and/or electronic gaming system 200 to choose the parameters before beginning auto-play (e.g., The player may select quit auto-play if you've won _X_ straight games option and also you want to auto-play at most _Y_ games option (e.g., X=1, 5, 10, 70, 500, 1000, 10000, etc. and Y=2, 3, 4, 9, 15, 50, 100, 500, 5000, etc.). The game may play until whichever of the parameters happens first and then turn-off the auto-play mode, or the game may be set to continue playing until all events have been finished). Please note that auto play functionality may be auto play functionality for persistent state gaming options and/or a stand alone function.

In another example, the player may select that electronic gaming device 100 and/or electronic gaming system 200 chooses the criteria for the auto-play functionality. Electronic gaming device 100 and/or electronic gaming system 200 may choose one parameter, more than one parameter, a combination of parameters that may be needed to be completed before the auto-play mode turns off, a number of parameters where only one needs to be satisfied before the auto-play functionality turns off, a saved profile from the player's identification card, a predetermined assigned order, by a predetermined pattern, shuffle, any combination thereof, and/or any other selection method.

Electronic gaming device 100 and/or electronic gaming system 200 may chose that all criteria need to be satisfied, only a select number of criteria need to be satisfied, only specific criteria need to be satisfied, and/or only one criteria needs to be satisfied before the auto-play functionality may turn off (e.g., electronic gaming device 100 and/or electronic gaming system 200 may chose the criteria: you want to auto-play at most _{—}35_{—} minutes only, auto-play until your credit reaches _{—}550_, you want to quit auto-play if your credit falls below _{—}3_, quit auto-play if you don't win for _{—}15_{—} straight games, quit auto-play if you've won _{—}30_ straight games, quit auto-play if a single game wins over _{—}8000_{—} credits, quit auto-play after a total of _{—}70_ winning games, quit auto-play after a total of _{—}50_ losing games, you want to auto-play at most 80_ games, auto-play until a total of _{—}400_ credits is spent, quit auto-play if _{—}30_{—} out of _{—}100_ games didn't win anything, and you want to quit auto-play if you hit a _progressive jackpot_. Electronic gaming device 100 and/or electronic gaming system 200 may chose all of the parameters to be satisfied before the auto-play functionality may turn off).

The player may select all of the criteria. The player may set the criteria to all need to be satisfied, only a select number need to be satisfied, only specific criteria need to be satisfied, and/or only one criteria needs to be satisfied before the auto-play functionality may turn off (e.g. a player may chose the criteria: you want to auto-play at most _{—}35_{—} minutes only, auto-play until your credit reaches _{—}550_, you want to quit auto-play if your credit falls below _{—}3_, quit auto-play if you don't win for _{—}15_{—} straight games, quit auto-play if you've won _{—}30_ straight games, quit auto-play if a single game wins over _{—}8000_ credits, quit auto-play after a total of _{—}70_winning games, quit auto-play after a total of _{—}50_ losing games, you want to auto-play at most 80_ games, auto-play until a total of _{—}400_ credits is spent, quit auto-play if _{—}30_{—} out of _{—}100_ games didn't win anything, and you want to quit auto-play if you hit a _progressive jackpot_. The player may chose that the first criteria satisfied may turn off the auto-play functionality. The player may also choose that all of the criteria need to be satisfied before the auto-play mode may turn off. The player may also choose that only a few of the criteria need to be satisfied before the auto-play functionality turn off).

The player may use drop-down menu 786 to select the amount from the options listed (e.g., 5, 10, 30, 50, 100, etc.). Drop-down menu 786 may be a pull-down menu, a fill-in area, a voice-recognition box, and/or any other data entry image. Selected criteria 784 may list which parameters have been selected (e.g., if the player has selected drop-down menu 786 in the first parameter for 5 minutes, selected criteria may read, “You want to auto-play at most 5 minutes only”). Selected criteria may also list the parameters as an and/or option (e.g., if the player wants the parameters to be for the auto-play to continue for 5 minutes only or for the game to quit after hitting the jackpot event, the player may select the two parameters and change the auto-play from “and” to “or” to allow the auto-play to turn off with either of the two parameters. A player may also determine that they want electronic gaming device 100 and/or electronic gaming system 200 to decide if the criteria should both be satisfied, one criteria satisfied, and/or a combination of criteria satisfied before the auto-play functionality turns off). Selected criteria may state, “None Selected,” until a parameter has been selected.

Computer select auto-play button 790 may be pressed if a player would like electronic gaming device 100 and/or electronic gaming system 200 to determine the criteria for the game to play in auto-play mode. Electronic gaming device 100 and/or electronic gaming system 200 may determine that all criteria needs to be satisfied, only a select number of criteria needs to be satisfied, only specific criteria needs to be satisfied, and/or only one criteria needs to be satisfied before the auto-play functionality may turn off (e.g., the player may select computer select auto-play button if the player would like electronic gaming device 100 and/or electronic gaming system 200 to determine the criteria for auto-play functionality. The computer may select for auto-play to continue for 5 minutes only or for the game to quit after hitting the jackpot event. In another example, electronic gaming device 100 and/or electronic gaming system 200 may determine the criteria to be that auto-play continues for 15 minutes only and for the game to quit after winning a total of 20 games).

Cancel button 792 may be clicked if the player determines they do not want to decide on the auto-play functionality options. This may take the player back to the main screen.

Image may include the auto-play criteria, the parameters and examples, drop-down menu, a chosen criteria, a listed criteria, a save criteria button, a computer choose auto-play criteria, cancel button, and an accepted criteria. Auto-play criteria may be a menu of options a player may choose from in order to adapt their auto-play functionality experience. Any combination of parameters may be selected for play. Parameters may include one or more of a time duration, a positive credit, a negative credit, a losing streak, a winning streak single winning total, a winning play count, a losing play count, number of games, an amount spent, a percentage lost, and a jackpot event. One or more drop-down menus may represent a pull-down menu, a fill-in area, a voice-recognition box, and/or any other data entry image. An example of each parameter 604 may include the player wants to auto-play at most _X_ minutes only (e.g., X=1, 5, 10, 70, 500, 1000, 10000, etc.), auto-play until your credit reaches _X_ (e.g., X=1, 5, 10, 70, 500, 1000, 10000, etc.), you want to quit auto-play if your credit falls below _X_ (e.g., X=1, 5, 10, 70, 500, 1000, 10000, etc.), quit auto-play if you don't win for _X_ straight games (e.g., X=1, 5, 10, 70, 500, 1000, 10000, etc.), quit auto-play if you've won _X_ straight games (e.g., X=1, 5, 10, 70, 500, 1000, 10000, etc.), quit auto-play if a single game wins over _X_ credits (e.g., X=1, 5, 10, 70, 500, 1000, 10000, etc.), quit auto-play after a total of _X_ winning games (e.g., X=1, 5, 10, 70, 500, 1000, 10000, etc.), quit auto-play after a total of _X_ losing games (e.g., X=1, 5, 10, 70, 500, 1000, 10000, etc.), you want to auto-play at most _X_ games (e.g., X=1, 5, 10, 70, 500, 1000, 10000, etc.), auto-play until a total of _X_ credits is spent (e.g., X=1, 5, 10, 70, 500, 1000, 10000, etc.), quit auto-play if _X_ out of _Y_ games didn't win anything (e.g., X=1, 5, 10, 70, 500, 1000, 10000, etc. and Y=2, 3, 4, 9, 15, 50, 100, 500, 5000, etc.), and you want to quit auto-play if you hit a jackpot. The player may select one parameter, any combination of any of the parameters, and/or ask electronic gaming device 100 and/or electronic gaming system 200 to choose the parameters before beginning auto-play (e.g., The player may select quit auto-play if you've won _X_ straight games option and also you want to auto-play at most _Y_ games option (e.g., X=1, 5, 10, 70, 500, 1000, 10000, etc. and Y=2, 3, 4, 9, 15, 50, 100, 500, 5000, etc.). The game may play until whichever of the parameters happens first and then turn-off the auto-play mode, or the game may be set to continue playing until all events have been finished).

The player may select one or a combination of any of these parameters before beginning auto-play functionality (e.g., the player may select quit auto-play if you've won _{—}40_ straight games and also you want to auto-play at most _{—}20_{—} games, etc.,). Electronic gaming device 100 and/or electronic gaming system 200 may play until one of the parameters is satisfied and then turn-off the auto-play mode, or electronic gaming device 100 and/or electronic gaming system 200 may be set to continue playing until all criteria have been satisfied. Electronic gaming device 100 and/or electronic gaming system 200 may also be set to decide if the criteria should both be met, one met, and/or a combination of factors before stopping auto-play). The player may use drop-down menu to select an amount from the options listed (e.g., 1, 5, 10, 30, 100, 9000 etc.). Once a player has selected from drop-down menu 620, the amount may be displayed in chosen criteria (e.g., if the player has selected drop-down menu 620 in the first parameter for 5 minutes, the first parameter may be set as, “You want to auto-play at most 5 minutes only”). Listed criteria may display what the player has selected as their auto-play criteria (e.g., Auto-play for at most 10 minutes). The player may choose as many parameters as desired. The player may also set the criteria in combination with each other, and/or set the criteria against each other (e.g., auto-play for at most 10 minutes and credits remaining greater than or equal to 9000 or until hit a bonus), and/or the player may select that electronic gaming device 100 and/or electronic gaming system 200 determines if the criteria should both be met, one met, and/or a combination of factors before the auto-play functionality turns off. Any number of criteria may be set in combination and/or against each other.

Save criteria button may allow the player to save their chosen criteria into a profile, which may be used at a later time by using their player's card. The casino, electronic gaming device 100, and/or electronic gaming system 200 may decide that only the elite players may have the ability to save different profiles. The casino, electronic gaming device 100, and/or electronic gaming system 200 may determine if a certain number of profiles are saved, the player may be awarded different things in order to encourage players to continuously use their profiles and/or to enhance their playing experience (e.g., a casino may award a player 20 comps if the player saves five or more profiles onto their player's card).

Computer choose auto-play criteria may be pressed if a player would like electronic gaming device 100 and/or electronic gaming system 200 to determine the criteria for the game to play in auto-play mode. Electronic gaming device 100 and/or electronic gaming system 200 may determine that all criteria needs to be satisfied, only a select number of criteria needs to be satisfied, only specific criteria needs to be satisfied, and/or only one criteria needs to be satisfied before the auto-play functionality may turn off (e.g. for example, the player may select computer choose auto-play criteria if the player would like electronic gaming device 100 and/or electronic gaming system 200 to determine the criteria for auto-play functionality. Electronic gaming device 100 and/or electronic gaming system 200 may select for auto-play to continue for 5 minutes only or for the game to quit after hitting the jackpot event. In another example, electronic gaming device 100 and/or electronic gaming system 200 may determine the criteria to be that auto-play continues for 15 minutes only and for the game to quit after winning a total of 20 games).

Cancel button may allow the player to close the auto-play criteria window and return to the main screen. Accepted criteria button may allow the player to select their chosen criteria and begin the auto-play mode.

FIG. 7H is an illustration of an auto-play criteria menu, according to one embodiment. An image 700H may include the auto-play criteria, the parameters and examples, a drop-down list 798A, a scroll button 798B, hand icon 796, a chosen criteria, a computer choose auto-play criteria, save criteria button, cancel button, and accepted criteria. Auto-play criteria may be a menu of options a player may choose from in order to adapt an auto-play mode experience. Any combination of parameters may be selected for play. Parameters may include one or more of a time duration, a positive credit, a negative credit, a losing streak, a winning streak single winning total, a winning play count, a losing play count, number of games, an amount spent, a percentage lost, and a jackpot event. One or more drop-down menus may represent a pull-down menu, a fill-in area, a voice-recognition box, and/or any other data entry image. An example of each parameter 604 may include the player wants to auto-play at most _X_ minutes only (e.g., X=1, 5, 10, 70, 500, 1000, 10000, etc.), auto-play until your credit reaches _X_ (e.g., X=1, 5, 10, 70, 500, 1000, 10000, etc.), you want to quit auto-play if your credit falls below _X_ (e.g., X=1, 5, 10, 70, 500, 1000, 10000, etc.), quit auto-play if you don't win for _X_ straight games (e.g., X=1, 5, 10, 70, 500, 1000, 10000, etc.), quit auto-play if you've won _X_ straight games (e.g., X=1, 5, 10, 70, 500, 1000, 10000, etc.), quit auto-play if a single game wins over _X_ credits (e.g., X=1, 5, 10, 70, 500, 1000, 10000, etc.), quit auto-play after a total of _X_ winning games (e.g., X=1, 5, 10, 70, 500, 1000, 10000, etc.), quit auto-play after a total of _X_ losing games (e.g., X=1, 5, 10, 70, 500, 1000, 10000, etc.), you want to auto-play at most _X_ games (e.g., X=1, 5, 10, 70, 500, 1000, 10000, etc.), auto-play until a total of _X_ credits is spent (e.g., X=1, 5, 10, 70, 500, 1000, 10000, etc.), quit auto-play if _X_ out of _Y_ games didn't win anything (e.g., X=1, 5, 10, 70, 500, 1000, 10000, etc. and Y=2, 3, 4, 9, 15, 50, 100, 500, 5000, etc.), and you want to quit auto-play if you hit a jackpot. The player may select one parameter, any combination of any of the parameters, and/or ask electronic gaming device 100 and/or electronic gaming system 200 to choose the parameters before beginning auto-play (e.g., The player may select quit auto-play if you've won _X_ straight games option and also you want to auto-play at most _Y_ games option (e.g., X=1, 5, 10, 70, 500, 1000, 10000, etc. and Y=2, 3, 4, 9, 15, 50, 100, 500, 5000, etc.). The game may play until whichever of the parameters happens first and then turn-off the auto-play mode, or the game may be set to continue playing until all events have been finished).

Electronic gaming device 100 and/or electronic gaming system 200 may play until one of the parameters is satisfied and then turn-off the auto-play mode, and/or the game may be set to continue playing until all the events have been satisfied, and/or the game may be set to continue playing until a select number of parameters have been satisfied). The player may use drop-down list to select an amount from the options listed (e.g., 1, 5, 10, 30, 55, 60, 100, etc.). Scroll button may allow the player to see where they are on drop-down list and may allow the player to use the up and down arrows to search the entire list of options (e.g., if a player can see 50, 55, 60, and 65, they may use the down arrow to also uncover options 70, 75, 80, 100). Hand icon may allow a player to hover over an option and click on the desired option (e.g., If a player wants to select save criteria button, they may move hand icon until it is over save criteria button and then click the button). Once a player has selected from drop-down list, the amount may be displayed in chosen criteria. Chosen criteria may display what the player has selected as their auto-play criteria (e.g., auto-play for at most 10 minutes). The player may choose as many parameters as desired, and once a second option has been added, electronic gaming device 100 and/or electronic gaming system 200 may ask if the player wants the second in combination with the first, to set the two opposing each other, or to allow electronic gaming device 100 and/or electronic gaming system 200 to decide (e.g., if the player has selected auto-play for 10 minutes only and quit auto-play after a total of 4 winning games, and has selected the two criteria opposing each other, electronic gaming device 100 and/or electronic gaming system 200 may quit either after 10 minutes or 4 winning games, whichever occurs first. If a player selected auto-play for 10 minutes only and quit auto-play after a total of 4 winning games, and has selected the two criteria combining with each other, electronic gaming device 100 and/or electronic gaming system 200 may quit auto-play when both 10 minutes has elapsed and 4 winning games).

Computer choose auto-play criteria may be pressed if a player would like electronic gaming device 100 and/or electronic gaming system 200 to determine the criteria for the game to play in auto-play mode. Electronic gaming device 100 and/or electronic gaming system 200 may select an auto-play functionality and/or a persistent game play and/or one or more criteria for either of these functions. Electronic gaming device 100 and/or electronic gaming system 200 may select one of the profiles off of the player's card, use the player's history to determine the parameter that would take the player the longest to complete, randomly select criteria, use a predetermined pattern, shuffle, any combination thereof, and/or any other selection method. Electronic gaming device 100 and/or electronic gaming system 200 may determine that all criteria needs to be satisfied, only a select number of criteria needs to be satisfied, only specific criteria needs to be satisfied, and/or only one criteria needs to be satisfied before the auto-play functionality may turn off (e.g. electronic gaming device 100 and/or electronic gaming system 200 may select for auto-play to continue for 5 minutes only or for the game to quit after hitting the jackpot event, which may be on the player's card as Profile One. In another example, electronic gaming device 100 and/or electronic gaming system 200 may determine the criteria to be that auto-play continues for 15 minutes only and for the game to quit after winning a total of 20 games, which may be the player's preferred auto-play mode. In another example, electronic gaming device 100 and/or electronic gaming system 200 may determine the criteria to be that auto-play continues for 15 minutes only and for the game to quit after winning a total of 20 games).

Save criteria button may allow the player to save their chosen criteria into a profile. Profiles may be used at a later time when accessed by the player's identification card. The casino, electronic gaming device 100, and/or electronic gaming system 200 may decide that only the elite players may have the ability to save different profiles. The casino, electronic gaming device 100, and/or electronic gaming system 200 may determine if a certain number of profiles are saved, the player may be awarded different things in order to encourage players to continuously use their profiles and/or to enhance their playing experience (e.g., a casino may award a player 20 comps if the player saves five or more profiles onto their player's card). Cancel button may allow the player to turn off the auto-play criteria window and return to the main screen. Accepted criteria may allow the player to select their chosen criteria and begin the auto-play mode.

FIG. 7J is an illustration of an auto-play criteria menu, according to one embodiment. Another image 700J may include auto-play criteria, parameters, examples, drop-down list, chosen criteria, recall criteria button 703, and cancel button 705. Auto-play criteria may be a menu of parameters that a player may choose from in order to manipulate the auto-play functionality. Any combination of parameters may be selected for play. Parameters may include may include one or more of a time duration, a positive credit, a negative credit, a losing streak, a winning streak single winning total, a winning play count, a losing play count, number of games, an amount spent, a percentage lost, and a jackpot event. One or more drop-down menus may represent a pull-down menu, a fill-in area, a voice-recognition box, and/or any other data entry image. An example of each parameter 604 may include the player wants to auto-play at most _X_ minutes only (e.g., X=1, 5, 10, 70, 500, 1000, 10000, etc.), auto-play until your credit reaches _X_ (e.g., X=1, 5, 10, 70, 500, 1000, 10000, etc.), you want to quit auto-play if your credit falls below _X_ (e.g., X=1, 5, 10, 70, 500, 1000, 10000, etc.), quit auto-play if you don't win for _X_ straight games (e.g., X=1, 5, 10, 70, 500, 1000, 10000, etc.), quit auto-play if you've won _X_ straight games (e.g., X=1, 5, 10, 70, 500, 1000, 10000, etc.), quit auto-play if a single game wins over _X_ credits (e.g., X=1, 5, 10, 70, 500, 1000, 10000, etc.), quit auto-play after a total of _X_ winning games (e.g., X=1, 5, 10, 70, 500, 1000, 10000, etc.), quit auto-play after a total of _X_ losing games (e.g., X=1, 5, 10, 70, 500, 1000, 10000, etc.), you want to auto-play at most _X_ games (e.g., X=1, 5, 10, 70, 500, 1000, 10000, etc.), auto-play until a total of _X_ credits is spent (e.g., X=1, 5, 10, 70, 500, 1000, 10000, etc.), quit auto-play if _X_ out of _Y_ games didn't win anything (e.g., X=1, 5, 10, 70, 500, 1000, 10000, etc. and Y=2, 3, 4, 9, 15, 50, 100, 500, 5000, etc.), and you want to quit auto-play if you hit a jackpot. The player may select one parameter, any combination of any of the parameters, and/or ask electronic gaming device 100 and/or electronic gaming system 200 to choose the parameters before beginning auto-play (e.g., The player may select quit auto-play if you've won _X_ straight games option and also you want to auto-play at most _Y_ games option (e.g., X=1, 5, 10, 70, 500, 1000, 10000, etc. and Y=2, 3, 4, 9, 15, 50, 100, 500, 5000, etc.). The game may play until whichever of the parameters happens first and then turn-off the auto-play mode, and/or the game may be set to continue playing until all events have been finished). The player may select one or a combination of any of parameters examples before beginning the auto-play mode (e.g., the player may select “quit auto-play if you've won _X_ straight games” and also “you want to auto-play at most _Y_ games”. Electronic gaming device 100 and/or electronic gaming system 200 may play until whichever of the parameters happens first and then turn-off the auto-play mode, or electronic gaming device 100 and/or electronic gaming system 200 may be set to continue playing until all the events have finished, or electronic gaming device 100 and/or electronic gaming system 200 may be set to determine the auto-play criteria). The player may use drop-down list to select the amount from the options available (e.g., 1, 5, 10, 30, 55, 60, 100, etc.). Once a player has selected from drop-down list, the amount may be displayed in chosen criteria. Chosen criteria may display what the player has selected as their auto-play criteria (e.g., auto-play for at most 10 minutes). The player may choose as many parameters as desired. When a second option has been added, electronic gaming device 100 and/or electronic gaming system 200 may ask if the player wants the second in combination with the first or to set the two opposing each other (e.g., if the player has selected “auto-play for 10 minutes only” and “quit auto play after a total of 4 winning games”, and has selected the two criteria opposing each other, electronic gaming device 100 and/or electronic gaming system 200 may quit auto-play either after 10 minutes or 4 winning games, whichever happens first. If a player selected “auto-play for 10 minutes only” and “quit auto play after a total of 4 winning games”, and has selected the two criteria combining with each other. Electronic gaming device 100 and/or electronic gaming system 200 may quit when it had been both 10 minutes and 4 winning games).

Chosen criteria may read “None Selected” until the player has changed one of example drop-drown list. Recall criteria button 703 may reset all of the drop-down lists to “Specify” (e.g., if a player has chosen one drop-down lists 608, but then changes his mind, the player may click on recall criteria button 703 to reset all of the options). Any number of examples 604 may be filled in before hitting recall criteria button 703. Once recall criteria button 703 has been clicked, all drop-down lists may return to stating, “Specify”. This feature may allow players to put in various criteria into drop-down list to see how it looks on chosen criteria before playing with the understanding that they can easily erase all of the chosen parameters (e.g., a player has selected “auto-play until a total of 10 credits are spent” and “auto-play until a total of 4 winning games.” The information is listed in the player's chosen criteria. The player may then click on recall criteria button 703 to reset all of the options. Chosen criteria may state, “Non Selected,” until the player makes a new selection). Cancel button may allow the player to turn off the auto-play criteria window and return to the main screen.

FIG. 7K is an illustration of a saved auto-play criteria menu, according to one embodiment. A third image 700K may include a saved auto-play criteria, a time stamp 709, a criteria 711, a criteria window 713, a profile name one 717A, a profile name two 707, a profile criteria list, a scroll bar 715, hand icon 725, a delete criteria button 719, cancel button 721, and an accept criteria button 723. Saved auto-play criteria may be a list of previously saved parameters that the player may choose from in order to manipulate their auto-play functionality experience. The player may create a profile name for each of the saved options. Each saved option may have a time entered into time stamp (e.g., profile one 717A was created on Apr. 25, 2012 at 10:11:33). Each saved profile may include the selected options as criteria (e.g., the player saved profile one 717A, which included auto-play for 10 minutes only, as the criteria.) The player may use hand icon to select between the different criteria, to click on the up/down arrows or the scroll bar on scroll bar, to select delete criteria button, to select cancel button, to select accept criteria button, and/or for any other purpose. The player may select delete criteria to erase a profile (e.g., the player may want to erase profile. The player may click on profile using hand icon. Once profile is highlighted, the player may use hand icon to click on delete criteria button. This may remove profile from profile criteria list). Cancel button may allow the player to close the save auto-play criteria window and return to the main screen (e.g., a player may want to return to the main screen if they are no longer interested in selecting from the saved criteria, or if they have finished editing their list of saved criteria). Accept criteria button may be used if a player wants to play a previously saved list of criteria. The player may use hand icon to highlight a specific profile from profile criteria list. Once highlighted, the player may use hand icon to click accept criteria button. The player may also use the touch-screen option to select a profile criteria list.

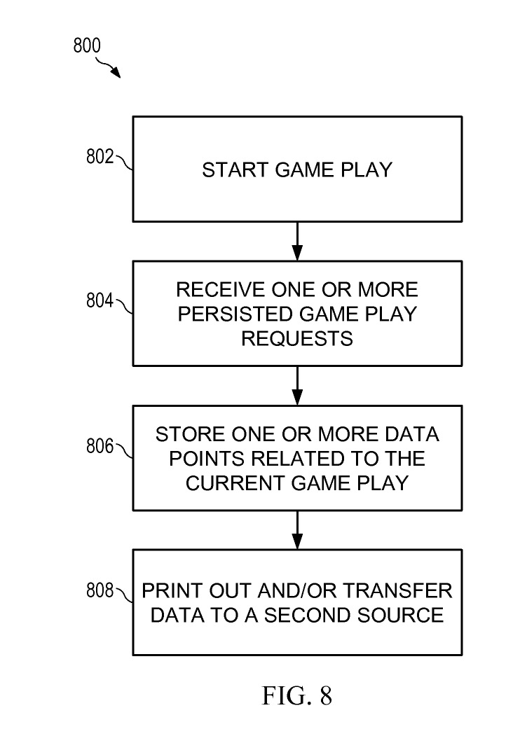

In FIG. 8, a game play flow diagram 800 is shown, according to one embodiment. The method may include the step of starting game play (step 802). The method may include receiving one or more persisted game play requests (step 804). The method may store one or more data points related to the current game play (step 806). The method may include printing out and/or transferring data (and/or data relating to game configuration) to one or more external source (e.g., a second source) (step 808).

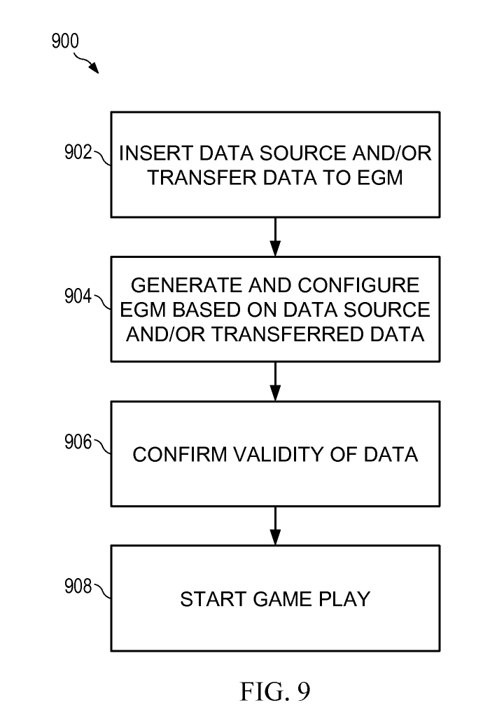

In FIG. 9, a game play flow diagram 900 is shown, according to one embodiment. The method may include inserting one or more data sources and/or transferring data to the electronic gaming machine (step 902). The method may include generating and/or configuring the electronic gaming machine based on one or more data sources and/or one or more transferred data (step 904). The method may include confirming the validity of one or more data points (step 906). The method may include starting game play (step 908).

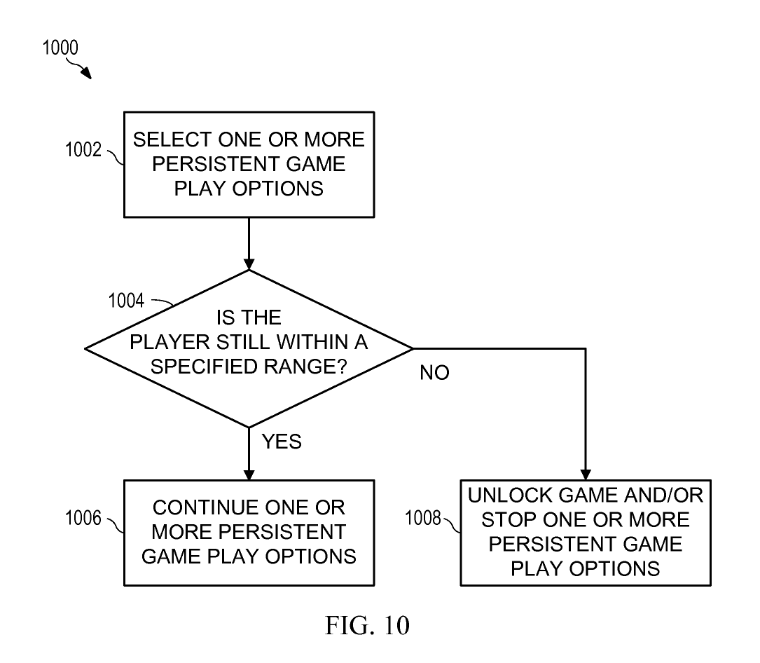

In FIG. 10, a flow diagram for game play 1000 is shown, according to one embodiment. The method may include selecting one or more persistent game play options (step 1002). The method may include one or more processors (e.g., the electronic gaming device, the electronic gaming system, and/or one or more servers) determining whether the player is still within a specified range (step 1004). If the player is not within the specified range, then the method may unlock the game and/or stop one or more persistent game play options (step 1008). If the player is within the specified range, then the method may include continuing one or more persistent game play options (step 1006).

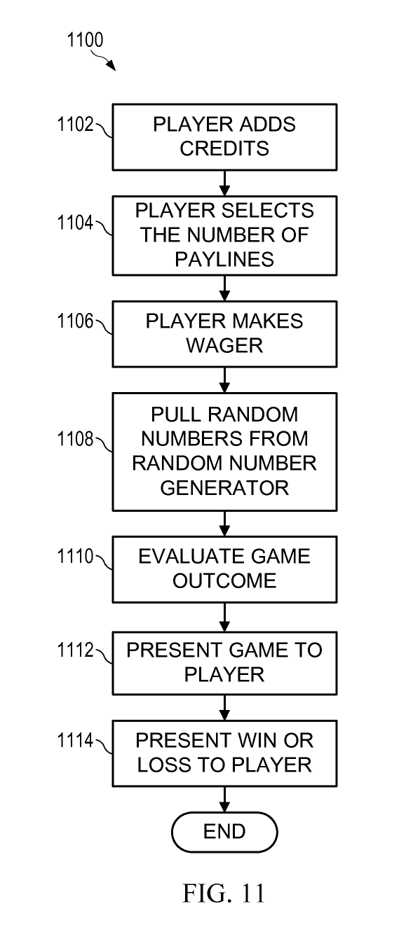

In FIG. 11, a process flowchart of one example of a primary game play 1100 on an electronic gaming system is shown, according to one embodiment. The method may include the step of a player adding credit to the electronic gaming system (step 1102). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1104, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1106, the player makes a wager on the game. In one embodiment, the wager may be a multiple of the number of paylines selected at step 1104. In another embodiment, the wager may not be a multiple of the number of paylines selected at step 1104. In a further embodiment, the wager may include a side-wager (e.g., ante bet), which may, in one example of such an embodiment, be used to make the player eligible to be awarded the extra functionality discussed above. It should be appreciated that in some embodiments, the order of steps 1104 and 1106 may be not critical, and so for example, a player can select the wager they wish to place, and then select the number of paylines they want it applied to, and that these embodiments are expressly contemplated as being within the scope of the present disclosure.

Continuing to step 1108, the gaming system pulls random numbers from a random number generator (“RNG”). In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At steps 1110 and 1112, the gaming system utilizes the random numbers pulled at step 1108 to determine the primary game symbols to display in the play of the primary game, which in turn both determines the presentation of the game to the player and evaluates the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1114, the win or loss outcome may be identified for the player. In one embodiment, this step can include additional messaging, which provides information related to the win or loss, such as why the player won or lost. In another embodiment, this step can include identification of the amount of any award earned by the player.

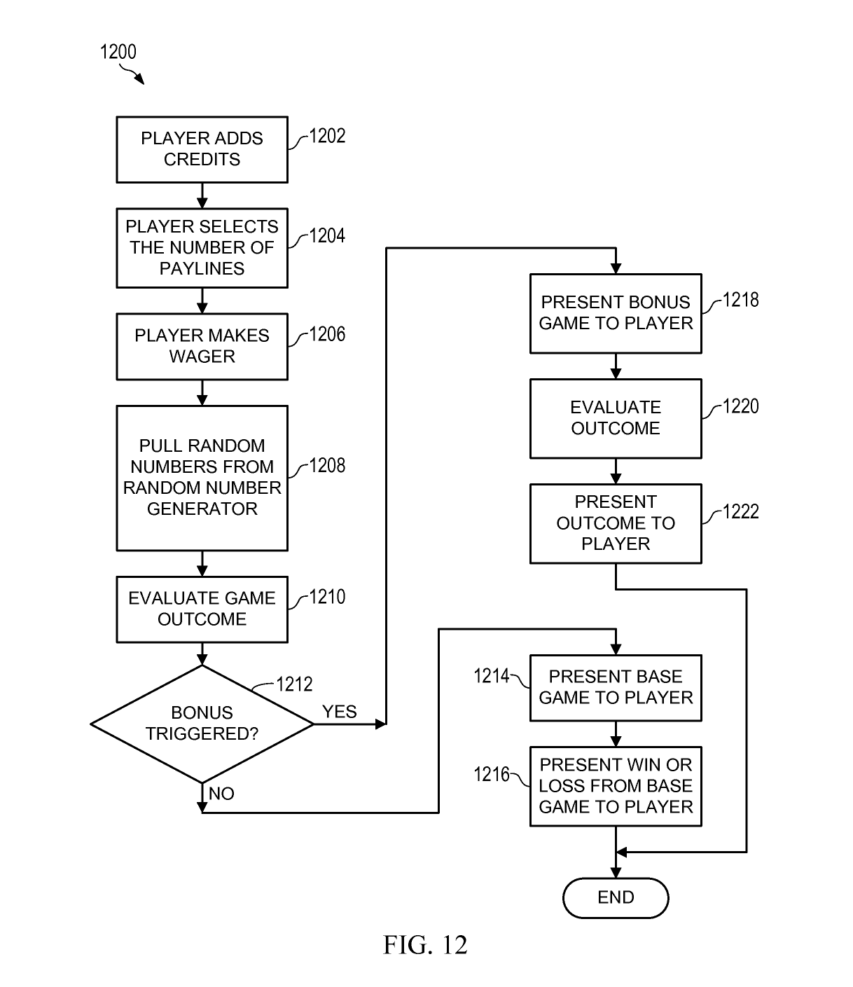

FIG. 12 is a process flowchart of one example of a combined primary and secondary game play 1200 on an electronic gaming system, according to one embodiment. The method may include the step of a player adding credit to the electronic gaming system (step 1202). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1204, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1206, the player makes a wager on the game. In one embodiment, the wager may be a multiple of the number of paylines selected at step 1204. In another embodiment, the wager may not be a multiple of the number of paylines selected at step 1204. In a further embodiment, the wager may include a side-wager, which may, in one example of such an embodiment, be used to make the player eligible to be awarded the extra functionality discussed above. It should be appreciated that in some embodiments, the order of steps 1204 and 1206 may be not critical, and so for example, a player can select the wager they wish to place, and then select the number of paylines they want it applied to, and that these embodiments may be expressly contemplated as being within the scope of the present disclosure.

Continuing to step 1208, the gaming system pulls random numbers from a random number generator “RNG”. In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At step 1210, the gaming system utilizes the random numbers pulled at step 1208 to evaluate the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1212, the gaming system determines if a secondary or bonus game may be triggered. In one embodiment, the bonus game is triggered by the display of a plurality of matching symbols at a plurality of predetermined symbol positions within a play of the primary game. In one example, the bonus game may be triggered if a plurality of matching symbols is displayed on the 2^{nd}, 3^{rd} and 4^{th} reel. In another example, the bonus game may be triggered if matching symbols are displayed on the 1^{st}, 2^{nd} and 3^{rd} reels. In a further example, the bonus game may be triggered if matching symbols occur at predetermined symbol positions that include consecutive and non-consecutive reels. In another example, a bonus game (e.g., secondary game) may be triggered in any way (e.g., one special symbols in any locations, one special symbol in one or more predetermined locations, two special symbols in any locations, two special symbols in one or more predetermined locations, three special symbols in any locations, three special symbols in one or more predetermined locations, etc.).

If it is determined that a bonus or secondary game was not triggered, the process continues to step 1214, where the base game may be fully presented to the player. As discussed above, the orders of step 1210, 1212, and 1214 can be changed without affecting the novel concepts disclosed herein.

At step 1216, the win or loss outcome of the primary game may be identified for the player. In one embodiment, this step can include additional messaging, which provides information related to the win or loss, such as why the player won or lost. In another embodiment, this step can include identification of the amount of any award earned by the player

If it is determined at step 1212 that a bonus or secondary game was triggered, then process 1200 continues to step 1218, where the secondary game may be presented to the player. As discussed above, there are numerous ways to present the secondary or bonus game to the player.

At steps 1220 and 1222, the outcome of the secondary game may be evaluated and presented to the player. In one embodiment, the outcome of the bonus game will always be a winning outcome. In another embodiment, the outcome of the secondary game will cause a significant award to be provided to the player. In one example of such an embodiment, the award may not be provided by the gaming system, as a casino operator may need to verify tax information before allowing such an award to be provided to the player. In one embodiment, instead of the process 1200 ending after step 1222, the process continues to step 1214 so as to finalize the primary game outcome presentation to the player.

In one example, a patron of a game may want to take a break and come back on any machine on the floor and continue with the same game play and/or game configuration. Once a patron decides to take a break he/she activates the persistent state feature using some action similar to a button activation which may record the persisting information including the game title, the denomination, pay lines, credit per lines, his current credits, any other bonus information, and/or any progressive information. In one example, after recording this information the device, system, and/or method may generate a unique number and/or any other information which identifies the state recorded which may be printed on a receipt and/or stored on a magnetic card based on the current setup. This may be further secured by providing an additional PIN number displayed which is required to be used to bring back the game state. Further, once he/she goes back to play, the machine may have an option to restore his/her session. Once the receipt and/or card is fed in the device, the system may validate the unique number or grid and optionally the PIN and/or biometric information and bring back and/or restore and/or load the previous game with the persisted title, denomination, payline, credit per line data, and/or the current available credits. This will enable the patron to continue to play from the prior saved state where he/she broke and/or stopped playing in the previous session.

In another example, the paytable may be transferred from the EGM to another device (e.g., mobile device, etc.). Further, jurisdictional information may be utilized to modify the saved persistent state game play. For example, a player may move from one jurisdiction to another which may require that the saved persistent state game play be modified. In one example, a player may move from Las Vegas to Atlantic City which would require that the game configuration be modified.

In one example, a player tracking can be combined with a persistent state game card to form a player tracking/persistent game card. In one example, the EGM may generate a greater number of random numbers (e.g., RNG) than would be needed for the persistent state game play to ensure that enough gaming outcomes are transferred from the EGM to the mobile device. In this example, random numbers from 1-1000 may be generated for a persistent state game play player which may be utilized on the mobile device while a second player playing on the EGM may start with random number 1001. In another example, bonuses, additional credits, additional spins, and/or any other reward may be utilized to entice a player to transfer game play to their mobile device and continue playing instead of not playing during their break (e.g., lunch, etc.).

In one embodiment, the electronic gaming device may include a plurality of reels. The plurality of reels includes one or more areas. The electronic gaming device may include a memory where the memory includes one or more persistent state modules. The electronic gaming device may include a processor where the processor may generate one or more symbols to be located in the one or more areas. The processor may generate one or more persistent game play data and to transfer the one or more persistent game play data.

In another example, the processor may generate a ticket which includes at least one of the one or more persistent game play data. Further, the processor may restart game play at a saved state based on at least one of the one or more persistent game play data. In addition, the processor may transfer at least one of the one or more persistent game play data to a magnetic card. In another example, the processor may restart game play at a predetermined phase based on at least one of the one or more persistent game play data. Further, the processor may transfer at least one of the one or more persistent game play data to a mobile device. In addition, the processor may initiate game play with a saved configuration based on at least one of the one or more persistent game play data. In one example, the processor may transfer game play data to a mobile device where the mobile device is configured to initiate a gaming session based on the transferred game play data. In addition, the processor may place the electronic gaming device into a reserved state based on the transferred persistent game play data. Further, the processor may initiate a warning based on reserved state becoming unreserved within a predetermined time period.

In another embodiment, a method of providing game play via an electronic mobile device may include generating via one or more processors one or more persistent game play data and transferring via the one or more processors the one or more persistent game play data.

The method may also include generating a ticket which includes at least one of the one or more persistent game play data; restarting game play at a saved state based on at least one of the one or more persistent game play data; transferring at least one of the one or more persistent game play data to a magnetic card; restarting game play at a predetermined phase based on at least one of the one or more persistent game play data; and/or transferring at least one of the one or more persistent game play data to a mobile device.

In another embodiment, the electronic gaming system may include a server including a server processor and a server memory. The system may include a display device including a plurality of reels where the plurality of reels includes one or more areas. The server memory includes one or more persistent state structures and the server processor may generate one or more symbols to be located in the one or more areas. The server processor may generate one or more persistent game play data and to transfer the one or more persistent game play data.

Further, the server processor may generate a ticket which includes at least one of the one or more persistent game play data. In addition, the server processor may transfer at least one of the one or more persistent game play data to a magnetic card. The server processor may transfer at least one of the one or more persistent game play data to a mobile device

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system is powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system is different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed. Further, one or more gaming options may be Internet based gaming options. Therefore, all of the examples and/or embodiments may be utilized via an Internet based gaming system.

1. An electronic gaming device comprising:
a plurality of reels, the plurality of reels including one or more areas;
a memory, the memory including one or more persistent state modules;
a processor configured to generate one or more symbols to be located in the one or more areas, the processor configured to generate one or more persistent game play data and to transfer the one or more persistent game play data.

2. The electronic gaming device of claim 1, wherein the processor is further configured to generate a ticket which includes at least one of the one or more persistent game play data.

3. The electronic gaming device of claim 2, wherein the processor is further configured to restart game play at a saved state based on at least one of the one or more persistent game play data.

4. The electronic gaming device of claim 1, wherein processor is further configured to transfer at least one of the one or more persistent game play data to a magnetic card.

5. The electronic gaming device of claim 4, wherein the processor is further configured to restart game play at a predetermined phase based on at least one of the one or more persistent game play data.

6. The electronic gaming device of claim 1, wherein the processor is further configured transfer at least one of the one or more persistent game play data to a mobile device.

7. The electronic gaming device of claim 6, wherein the processor is further configured to initiate game play with a saved configuration based on at least one of the one or more persistent game play data.

8. The electronic gaming device of claim 6, wherein the processor is further configured to transfer game play data to a mobile device where the mobile device is configured to initiate a gaming session based on the transferred game play data.

9. The electronic gaming device of claim 6, wherein the processor is further configured to place the electronic gaming device into a reserved state based on the transferred persistent game play data.

10. The electronic gaming device of claim 9, wherein the processor is further configured to initiate a warning based on reserved state becoming unreserved within a predetermined time period.

11. A method of providing game play via an electronic mobile device comprising:
generating via one or more processors one or more persistent game play data; and
transferring via the one or more processors the one or more persistent game play data.

12. The method of claim 11, further comprising generating a ticket which includes at least one of the one or more persistent game play data.

13. The method of claim 12, further comprising restarting game play at a saved state based on an insertion of the ticket which includes at least one of the one or more persistent game play data.

14. The method of claim 11, further comprising transferring at least one of the one or more persistent game play data to a magnetic card.

15. The method of claim 14, further comprising restarting game play at a predetermined phase based on an insertion of the magnetic card which includes at least one of the one or more persistent game play data.

16. The method of claim 11, further comprising transferring at least one of the one or more persistent game play data to a mobile device.

17. An electronic gaming system comprising:
a server including a server processor and a server memory;
a display device including a plurality of reels, the plurality of reels including one or more areas;
the server memory including one or more persistent state structures; and
the server processor is configured to generate one or more symbols to be located in the one or more areas, the server processor configured to generate one or more persistent game play data and to transfer the one or more persistent game play data.

18. The electronic gaming system of claim 17, wherein the server processor is further configured to generate a ticket which includes at least one of the one or more persistent game play data.

19. The electronic gaming system of claim 17, wherein server processor is further configured to transfer at least one of the one or more persistent game play data to a magnetic card.

20. The electronic gaming system of claim 17, wherein the server processor is further configured transfer at least one of the one or more persistent game play data to a mobile device.
